(19) United States
(12) Patent Application Publication
(10) Pub. No.: US 2005/0131725 A1
(43) Pub. Date: Jun. 16, 2005

(54) Mapping algorithm for identifying data required to file for state and federal tax credits related to enterprise zones, renewal communities, and empowerment zones

(76) Inventors: Gretchen Sleeper, Walnut Creek, CA (US); Sanford Livingston, Oakland, CA (US); Steve Valerius, Medina, MN (US); Rich Spieker, Burnsville, MN (US); Walter McFarland, St. Paul, MN (US)

Correspondence Address: GLENN PATENT GROUP, 3475 EDISON WAY, SUITE L, MENLO PARK, CA, 94025, US

(21) Appl. No.: 10/966,013

(22) Filed: Oct. 14, 2004

Related U.S. Application Data
(60) Provisional application No. 60/511,584, filed on Oct. 14, 2003.

(51) Int. Cl. G06F 17/60

(52) U.S. Cl. 705/1

(57) ABSTRACT

A system and method is provided for identifying data required to file for state and federal tax credits related to enterprise zones, renewal communities, and empowerment zones, that takes into account key entry errors and that scrubs data before inputting into a data mapping algorithm. The system and method significantly reduces the number of false negatives and false positives. The invention also includes identifying zone qualifiers by completing address information, including direction, such as North, South, East, and West.

### CROSS-REFERENCE TO RELATED APPLICATIONS

This application claims priority to U.S. Provisional Patent Application Ser. No. 60/511,584, filed on Oct. 14, 2003, Attorney Docket Number WELL0041 PR, which application is incorporated herein in its entirety by the reference thereto.

### BACKGROUND OF THE INVENTION

1. Technical Field

The invention relates generally to data scrubbing and data mapping algorithms. More particularly, the invention relates to a data scrubbing and data mapping system and method for providing quality data needed to file confidently for identified tax credits.

2. Description of the Prior Art

Businesses can enhance their bottom line by exhausting opportunity in the area of tax incentive solutions. For example, a business can recoup otherwise lost dollars by applying for state and federal tax credit for which it qualifies. For example, California state tax credit can be given for employee hiring credits; fixed assets, such as sales and use tax credits; net interest income deductions for lenders; and other additional California credits, such as net operating loss deduction and depreciating of assets. Similarly, in the area of federal tax, credit can be given to a business for employee hiring credits, work opportunity tax credit, and welfare-to-work. According to HUD No. 02-008 Brian Sullivan, News Release, The Department of Housing and Urban Development, Jan. 15, 2002, http://www.hud.gov/news/release.cfm?content=pr02-008.cfm, which is herein incorporated by reference, Empowerment Zones authorized by the 2000 Community Renewal Tax Relief Act “use the power of public and private partnerships to build a framework of economic revitalization in areas that experience high unemployment and shortages of affordable housing.” Sullivan further explains that “Empowerment Zones encourage public-private partnership to generate economic development in some of the nation's most distressed urban communities.” In January 2002, “the Bush administration announced community revitalization efforts. In particular, HUD announced an estimated $17 billion in tax incentives to stimulate job growth, promote economic development, and create affordable housing opportunities by declaring eight new Empowerment Zones across the country.” Further, according to Sullivan, “the new urban Empowerment Zones (EZs) will receive regulatory relief and tax breaks to help local businesses provide more jobs and promote community revitalization.”

Hereinbelow further is provided by Sullivan.
These new EZs can take advantage of wage credits, tax deductions, bond financing and capital gains to stimulate economic development and job growth. Each incentive is tailored to meet the particular needs of a business and offers a significant inducement for companies to locate and hire additional workers.
   Tax Credits
Wage credits are especially attractive to businesses looking to grow.

These businesses are able to hire and retain Zone residents and apply the credits against their federal tax liability. Businesses located within the new Empowerment Zones will enjoy up to a $3,000 credit for every newly hired or existing employee who lives in the EZ.
Work Opportunity Credits provide businesses located with Empowerment Zones up to $2,400 against their Federal tax liability for each employee hired from groups with traditionally high unemployment rates or other special employment needs, including youth who live in the EZ.
Welfare to Work Credits offer EZ businesses a credit of up to $3,500 (in the first year of employment) and $5,000 (in the second year) for each newly hired long-term welfare recipient.”
   Bond Financing

In addition to the wage credits, there are significant tax incentives available in support of qualified zone property and schools with the EZs.
Tax-Exempt Facility Bonds help Empowerment Zone businesses to receive lower-cost loans to finance property, purchase equipment and develop business sites within these communities.
Qualified Zone Academy Bonds allow state and local governments to match no-interest loans with private funding sources to finance public school renovations and programs.
   Capital Gains

Businesses located within EZs can postpone or only partially recognize the gain on the sale of certain assets, including stock and partnership interests. This benefit significantly reduces the capital gains tax liability on businesses located with these designated areas.

Tax Deductions

Under Section 179 of the tax code, businesses located with EZs may claim increased expensing deductions up to $35,000 for depreciable property such as equipment and machinery acquired after Dec. 31, 2001.
Environmental Cleanup Cost Deductions allow businesses to deduct qualified cleanup costs in Brownfields.

In addition to the incentives described above, HUD will provide technical assistance to these communities to ensure that businesses are fully aware of the many opportunities available to them. To make certain the Empowerment Zones are successful in the initial stages of their designations, HUD will host an Implementation Conference where the newly designated EZs will meet to hear from experts in the fields of business, taxes and economic development. The conference will also provide presentations from representatives from previously designated EZs recognized for their successes in forming public-private partnerships.

Other Incentives

Like all distressed communities, Empowerment Zones will also be able to take advantage of the New Markets Tax Credits that provide investors with a credit against their federal taxes of 5 to 6 percent of the amount invested in a distressed area. Also available to Empowerment Zones is the Low-Income Housing Tax Credit providing credit against Federal taxes for owners of newly constructed or renovated rental housing.
   Empowerment Zone History
The first six of the current 30 Urban Empowerment Zones were designated in 1994. They were created to establish an initiative that would rebuild communities in America's poverty-stricken areas through incentives that would entice businesses back to the inner cities. In 1998, the Initiative was expanded through a second round, incorporating an additional 15 zones and changing the designation of two Supplemental Empowerment Zones to the full status of EZs.
The 2000 Community Renewal Tax Relief Act established this round of Empowerment Zones. HUD received 35 Empowerment Zone applications from urban communities around the country. Successful Empowerment Zone applicants had to satisfy a two-part selection process that weighed certain population and poverty criteria as well as the quality of the community's strategic plan.

According to Andrew Bershadker and Edith Brashares, Use of the Federal Empowerment Zone Employment Credit for Tax Year 1997: Who Claims What?, www.irs.gov/pub/irs-soi/97empow.pdf, Congress authorized the federal program whereby selected geographic areas across the United States became eligible for special tax incentives and federal funding. From an initial set of areas nominated for designation, nine areas were designated empowerment zones and 95 were designated enterprise communities, with Congress allofting most of the tax incentives and federal funding to empowerment zones.

Obstacles to filing for state and federal tax credit include the following. Current tools have been found inadequate for identifying data that can be used for filing both state and federal tax credits. Also, for various reasons, businesses have not regularly filed for such credit in the past. One obstacle to filing for such credit included the fact that the data were too difficult to analyze. Some businesses went to outside vendors to handling prior years' filings of tax credit. However, it had been discovered that the results contained high level of errors, resulting in an expensive and lower than expected result. Another obstacle in the past was simply little or no electronic access to the relevant data.

Some work has been done in the area, and, in particular, by Chun PongYu, System with Improved Methodology for Providing International Address Validation, U.S. Pat. No. 6,575,376, Jun. 10, 2003. Yu teaches an ability to validate addresses as the address is being entered in a variety of address formats that adhere to postal standards in various countries. The CPU efficiency of the above processing task is increased by translating address field contents into an abbreviated compact format which can be compared with less resources. The system checks to verify that all required fields have been entered and that errors in entries are corrected for normalization purposes. It should be appreciated that the teachings describe a database software system with the ability to recognize written foreign languages and address patterns from various common-language countries, for example, that of the U.S. and Australia. Such system then compares and validates the address entries with the country-specific postal requirements. It should further be appreciated that the Yu disclosure is concerned with verifying completeness of address entries; validating individual addresses as such are being entered into the Yu system, and abbreviating addresses into a compact format to conserve CPU resources.

It would be advantageous to provide institution-wide ability to find accurate data to file for tax credits related to enterprise zones in California and federal empowerment zones territory wide.

It would also be advantageous to provide a system and method for providing corporate tax staff users with quality data needed to confidently file for identified tax credits which would otherwise be forgone.

It would also be advantageous to provide a system and method for providing a targeted list of firms in California zones; mapping a business' location to California and federal zones with a high level of accuracy; mapping client locations to California and federal zones; mapping employees to Targeted Employment Area (TEA) zones in California and federal empowerment zones; and calculating credits with flexibility for large corporations with multiple source systems and diverse organizational structures.

### SUMMARY OF THE INVENTION

A system and method is provided for identifying data required to file for state and federal tax credits related to enterprise zones, renewal communities, and empowerment zones, that takes into account key entry errors and that scrubs data before inputting into a data mapping algorithm. The invention also includes identifying zone qualifiers by completing address information, including direction, such as North, South, East, and West. The invention significantly reduces the number of false negatives and false positives.

### BRIEF DESCRIPTION OF THE DRAWINGS

FIG. 1 is a high-level block diagram of a tax credit scrubbing and mapping system according to the invention;

FIG. 2 is a schematic diagram showing example input parameters and a categorization used in the tax credit scrubbing and mapping system according to the invention; and

FIG. 3 is an example schema for output scrubbed and mapped data in concert with particular zones according to the invention.

### DETAILED DESCRIPTION OF THE INVENTION

A system and method is provided for identifying data required to file for state and federal tax credits related to enterprise zones, renewal communities, and empowerment zones, that takes into account key entry errors and that scrubs data before inputting into a data mapping algorithm. The invention also includes identifying zone qualifiers by completing address information, including direction, such as North, South, East, and West. The invention significantly reduces the number of false negatives and false positives.

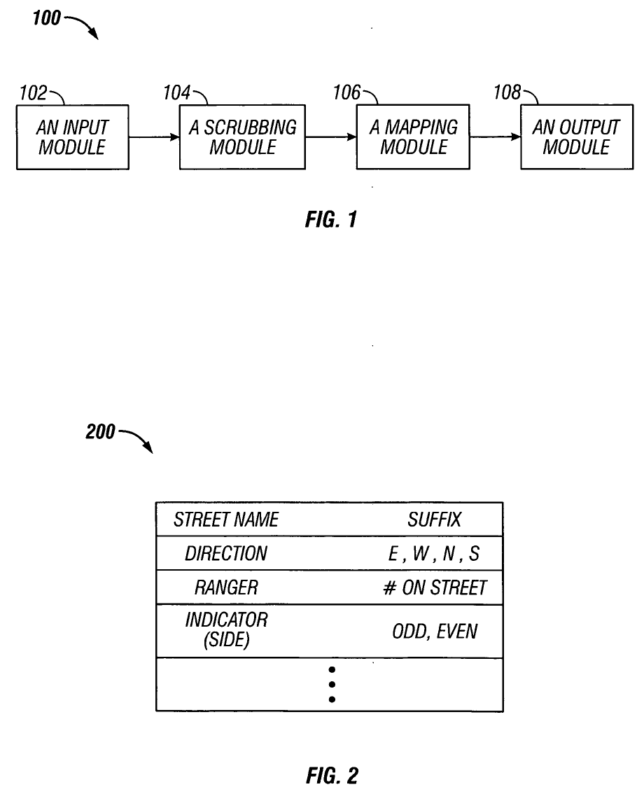

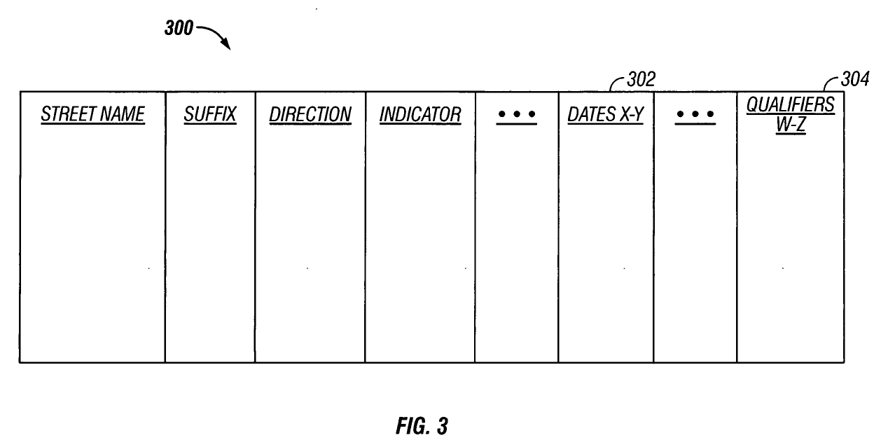

One embodiment of the invention can be described with reference to FIG. 1, a high-level block diagram of a tax credit scrubbing and mapping system. An input module 102 receives an input file from a government source, such as the state of California, and outputs a parsed file to the scrubbing module 104. It should be appreciated that the input file can be a file such as a PDF file and the parsed output file can be a simple text or spreadsheet file. The scrubbing module process can be described with reference to FIG. 2, a schematic diagram 200 showing example input parameters and a categorization used in the tax credit scrubbing and mapping system. Upon receiving the parsed input file, the scrubbing module applies rules to particular categories of data. In one embodiment of the invention, a rule is applied by which is spaces are found in a street name, the spaces are stripped out. If no spaces are detected, then the street name stays exactly the same. In another embodiment of the invention, the address record is compared with a previously stored address file. If the input suffix matches that of the preexisting file, then it is kept; if there is no suffix, then none is kept; otherwise, if there is a suffix by no match, the suffix is not kept. In another embodiment of the invention, if no direction is present in a given input record, then no direction is stored in the output file for that address. If the input record does have an entry in the direction field, then it must be equal to that of the previously stored file for it to be kept. Otherwise, it is ignored. A range is determined by the street numbers. Zones may exist for only one side of a given street, hence, an odd and even indicator is stored in the output file. An example resultant set of data can be described with reference to FIG. 3, an example schema for output scrubbed and mapped data 300 in concert with particular zones. In one embodiment of the invention, a date range 302 is added to the input data according to the interval of time in which the particular zone is in effect. It should be appreciated that adding such date range makes it possible to perform a backfiling process for obtaining tax credits from an earlier year. In another embodiment of the invention, the table 300 is expanded to include more qualifiers 304 for each added state. That is, it should be appreciated that as states are added to the system, each added state has specific qualifiers. Therefore, the invention allows for the system to be flexible and expand to include zones for more states, such as by adding qualifiers to the mapped product 300, as shown in FIG. 3.

It should be appreciated that one embodiment of the invention scrubs and maps addresses of input files of zones, but leaves out the city field. Leaving out the city is found to be useful in this embodiment because the mapping subsystem is a many-to-many relationship. A zone can have multiple cities and a city can be in multiple zones.

### An Exemplary Address Scrubbing Process

One embodiment of the invention can be described with reference to a California Empowerment Zone (CA EZ) scrubbing process. It should be appreciated that discussion of the CA EZ scrubbing process is by way of example only and that variations, e.g. other states and other types of zones, are included and within the spirit and scope of the invention.

The California Technology, Trade and Commerce Agency provides CA Enterprise Zone and Targeted Employment Area address ranges to the public on their website: http://www.commerce.ca.gov/state/ttca/ttca homepage.isp. In one embodiment of the invention, a general process is used to sort all of the EZ and TEA addresses into one consistent format, as follows:
From an input file, such as a PDF file, an address range link for each zone is opened with an application, such as Adobe Acrobat®;
All data is copied and saved as a text file;
Saved data is opened in a spreadsheet application, importing from a text delimited file, e.g. where delimiter=space;
Address components are manually placed into correct columns where the import results in misalignment; and
All EZ and TEA spreadsheet files are combined into one file.

It was found that the PDF (Adobe Acrobat®) files were poorly designed for import. Of all the import options, space delimiting is the only useful table import option given the state of the PDF files. A substantial number of misalignments results from space delimiting and the varying PDF format.

In one embodiment of the invention, one or more input PDF records are parsed into five columns: range: [from (street number), to (street number)], side (odd or even), direction (compass), street name, and suffix.

Street names with two or more words are concatenated. In one embodiment of the invention, an entire concatenated column is copied over with paste value for import into a single table to be used as input into a main calculating system or module, referred to herein as CRAAFS.

Some cities opted to put the direction in front of the name, so the process removes the direction from the name and puts the direction into a designated column. In the case when a direction in front of the street name and in the direction column, then the direction is left alone.

When side is named as “only”, then the same number is written in both the “from” and “to” columns and side is changed to “both”.

In one embodiment of the invention, a step is provided for copying EZ and TEA records into respective files, such as, for example, T_EZ_ADDRESSES.XLS and T_EZTEA_ADDRESSES.XLS. In such files, a sixth column is added with zone ID's. Then, such tables are imported into the system using the same table names.

CA EZ Address—City variations

It was discovered that some cities have large variations in PDF format and need to be adjusted before being saved to a spreadsheet, such as Microsoft Excel. Some PDF files could not be imported at all.

Following is a list of exceptions for Enterprise Zone and Targeted Employment Area. Such list is by way of example only is does not in any way limit the invention. It should be appreciated that the variations on the list of exceptions is practically endless and is within the spirit and scope of the invention.

Enterprise Zone

Antelope Valley: removed city (Palmdale/Lancaster);

Auga Mansa: removed city (Colton);

Bakersfield: entered manually. Some records said, for instance, 100 to 200 even

(exclude 152). Such are changed into two records: 100-150 even, 154-200 even;

Coachella: removed hyphens in numbers;

Kings: removed county name;

Los Angeles: separated by zone, removed all “yes” zones (they were empowerment not enterprise); and

Watsonville: instead of three columns: from/to/side, there were four columns: low even/high even/low odd/high odd. The street name, suffix and direction were copied and pasted into a new row and the odd addresses cut and pasted into place. Records that were only even or odd are sorted manually.

Targeted Employment Area

Altadena Pasadena: combined first direction with street name. Some sides were written as directions, changed all sides to “both”;

Calexico: removed all parentheses;

Fresno: Instead of three columns: from/to/side, there were four columns: low even/high even/low odd/high odd. The street name, suffix and direction were copied and pasted into a new row and the odd addresses cut and pasted into place. Records that were only even or odd are sorted manually;

Kings: removed column A & B, “HFD” and any other obscure letters, i.e. A, B, C, etc. and second instance of street name and suffix;

Merced: removed backslash and city (Merced/Atwater/Dospalos);

Oakland: removed zip code and census tract number;

Oroville: instead of one table arranged alphabetically, there were three tables of records, side by side. First each table is organized by the five columns and then combined into one table;

San Diego Barrio Logan: removed “0” in front of number streets manually. Also removed council district number and census tract number;

San Diego Otay Mesa/ San Ysidro: Removed council district number, census tract, and city;

San Jose: removed commas at the end of suffixes;

Santa Ana: removed city, zip, description and census tract number;

San Francisco: removed “0” at the begging of number streets manually. Also removed census tract number;

Watsonville: entered manually, delimited file wouldn't transfer;

West Sacramento: only zip code 95605 included. No Excel file made since it wouldn't fit the format of T_EZ_ADDRESSES; and

Yuba Sutter: removed zip code, census tract number and county.

The result is a set of scrubbed data. The resulting scrubbed data is ready to be used as input into a zone mapping process as described in the following section.

It should be appreciated that at this stage, the name of the city is excluded because a zone can cover multiple cities, wherein one or more cities within the zone can have a same address. For example, both Oakland, Calif. and Emeryville, Calif. have 11^{th} Street.

It should further be appreciated that the resultant data is parsed in concert with a predefined zone.

### An Exemplary Address Matching to Zone Address Ranges Process

Presently, there are two general methods of qualifying addresses, graphical and text matching.

The graphical method. Incorporating a graphical overlay depicting zone perimeter on top of a street mapping application, addresses can be designated as being within or outside of the perimeter.

A Problem. This method of address qualification has shown to be highly inaccurate and results in over-qualifying addresses. This method is especially faulty with zones that are specific about the address range for a given zone street and with zones the perimeters of which lie in heavily populated districts.

Compensation. It has been found that to reduce the level of false positive matches, the graphical overlay is can be in size such that the zone perimeters are pulled back toward the center of the zone. This leads to a substantial number of false negatives; again particularly in zones the perimeters of which lie in heavily populated districts

The text matching method. By simply comparing the alphanumeric text in address fields, addresses may be matched from one source to another but the match rate is generally very poor.

For example, whereas the human mind can scan through the below addresses and determine that the locations are the same, a generic database application without software for address matching scans the same addresses comparing every space, alphanumeric character, and punctuation mark, and then determine that the address are not the same.

Address A: 123 N. 4th, #45

L.A. Calif. 90022

Address B: 123 North Fourth Street, Suite 45

Los Angeles, Calif.

Address C: 123N 4th Str, No. 45

Los Angles Calif. 90022

Conversely, the human mind cannot efficiently compare large number of addresses whereas a generic database application can. For example. a list of fifty thousand addresses compared to another list of fifty thousand addresses may require two and a half trillion comparisons.

Address matching software is not an exact science. Numerous software exists to marry computer database application speed with human accuracy. Software designers have numerous obstacles in the effort for a perfect marriage.

Human variations and errors. Busy data entry professionals generally do not conform to standard postal address conventions, especially punctuation. Spelling errors and keyboard typos.

Processing time. Even with the latest microchip processing capacity, software design must weigh the time-cost of each corrective step versus the resolution of above obstacles.

Common Address Matching Algorithms generally use a combination of below methods to overcome variations and errors.

Soundex is a technology that converts the phonetic sounds of a word into a series of coded symbols representing syllables. Therefore if the spelling sounds the same then the words are considered matches.

Scrubbing is usually not the preferred method by developers since it entails manually developing a list of misspellings and abbreviations. In most algorithms, some level of scrubbing is conducted.

Scoring is generally used due to above methods resulting in high levels of false-positive and false-negative matches. Each match of an address component results in an additional point. By setting the cutoff point score high, the end result is a high rate of false-negative matches. With a low cutoff score, the result is a high rate of false-positive matches. A common solution to the scoring dilemma is to create a more elaborate and hopefully more accurate scoring system. One that for example includes the position of the address component, within a given field, and increases the score if the matched components are in similar positions.

California EZ Zones

Table A below shows California EZ Zones.

TABLE A

```
Ague Mansa (Riverside, Colton, Rialto)
    Map | Colton Website, Riverside Website,
    Riverside County Website | Streets
Altadena/Pasadena
    Map | West Altadena Website, Pasadena
Website  |  Streets,
    TEA Streets
Antelope Valley (Palmdale, Lancaster, Los
Angeles  County)
    Map | Lancaster Website, Palmdale Website
    Streets | TEA Streets
Bakersfield
    Map | City Website, County Website |
Streets, TEA Streets
Calexico
    Map | Streets, TEA Streets
Coachella Valley (Coachella, Indio, Thermal)
    Map | Website | Streets
Delano
    Map | Website | Streets
Eureka
    Map | Website | Streets, TEA Streets
Fresno
    Map | Website | Streets, TEA Streets
Kings County (Hanford, Lemoore, Corcoran)
    Map | Website | Streets, TEA Streets
Lindsay
    Map | Website | Streets
Long  Beach
    Map | Website | Streets
Los  Angeles,  Central  City
    Map | Website | Streets
Los  Angeles,  Eastside
    Map | Website | Streets
Los  Angeles,  Northeast  Valley
    Map | Website | Streets
Los  Angeles,  Mid-Alameda  Corridor
(Los Angeles, Lynwood, Huntington Park,
South  Gate)
    Map | Website | Streets
Los  Angeles,  Harbor  Area
    Map | Website | Streets
Madera
    Map | Website | Streets, TEA Streets
Merced/Atwater
    Map | Merced Website | Streets, TEA Streets
Oakland
    Map | Website | Streets, TEA Streets
Oroville
    Map | Website | Streets, TEA Streets
Pittsburg
    Map | Streets
Porterville
    Map | Streets, TEA Streets
Richmond
    Map | Website | Streets
Sacramento,  Florin  Perkins
    Map | Website | Streets
Sacramento,  Northgate/Norwood
    Map | Website | Streets
Sacramento,  Army  Depot
    Map | Website
San  Diego-San  Ysidro/Otay  Mesa
    Map | Website | Streets, TEA Streets
San  Diego-Southeast/Barrio  Logan
    Map | Streets, TEA Streets
San  Francisco
    Map | Website | Streets, TEA Streets
San  Jose
    Map | Website | Streets, TEA Streets
Santa  Ana
    Map | Website | Streets
Shafter
    Map | Website | Streets, TEA Streets
Shasta Metro (Redding, Anderson, Shasta
Lake)
    Map | Website | Streets, TEA Streets
Shasta Valley (Yreka, Weed, Montague)
      Yreka map, Weed map, Montague map,
Airport  map
    Website | Streets
Stockton
    Map | Website | Streets, TEA Streets
Watsonville
    Map | Streets, TEA Streets
West  Sacramento
    Map | Website | Streets, TEA Streets
Yuba/Sutter (Yuba City, Marysville)
    Map | Website | Streets, TEA Streets
```

Table B is a table of State Programs and shows current states which offer lender deductions.

TABLE B

| | States: | | | | |
|---|---|---|---|---|---|
| | CA | IL | OR | RI | IN |
| Deduction | Net Interest Income | Interest | TBD | 10% Credit | 5% |
| Type | Deductions | Income | | on Interest | Credit |
| | | Deduction | | Income | on |
| | | | | | Interest |
| | | | | | Income |
| Revenue | Interest income, | TBD | TBD | TBD | TBD |
| deductible: | Points, Escrow Fee, | | | | |
| Costs | Cost of funds & | TBD | TBD | TBD | TBD |
| subtracted | direct expenses | | | | |
| from | incurred in making | | | | |
| Revenue | loan. | | | | |
| Conditions | Located solely in EZ | TBD | TBD; | TBD | TBD |
| on Trade or | | | rehab | | |
| Business | | | only?? | | |
| Conditions | No equity or other | TBD | TBD | Lender | TBD |
| on Lender | ownership interest in | | | must keep | |
| | trade of business | | | copy of | |
| | | | | certification. | |
| Conditions | Loan made after EZ | TBD | TBD | TBD | TBD |
| on Loan | designation date. | | | | |
| | Money used for | | | | |
| | business activities | | | | |
| | within EZ. | | | | |
| Exclusions | EZ designation | TBD | TBD | TBD | TBD |
| | expiration Business | | | | |
| | moves out of EZ. | | | | |
| Tax Board | Enterprise Program | TBD | TBD | TBD | TBD |
| Contacts | Hotline: (916) 324-8211 | | | | |
| State | Trade & Commerce | TBD | TBD | TBD | TBD |
| Program | Commission; EZ | | | | |
| Contacts | Mapping: Michelle | | | | |
| | Adams (916) 322-2864 | | | | |

An Exemplary Embodiment—Net Interest Deduction for Lenders

It should be appreciated that the following discussion is meant by way of example only and that other embodiments and variations are within the spirit and scope of the invention. For example, the following discussion focuses on the state of California, but it is readily apparent that modifications and adjustments made to accommodate other states are well within the scope and spirit of the invention. Also, the discussion employs names for specific systems and tables, but it should be appreciated that such labels are also by way of example and are by no means meant to be limiting.

It should further be appreciated that one embodiment of the invention contains a system referred to as CRAAFS which performs the automatic scrubbing and address matching functionality and such reference is by way of example only, for ease of reading and understanding, and does not in any way limit the invention.

Qualifications

California

2001 FTB Publication-1047 states that a lender can take a deduction for the amount of “net interest” earned on loans made to a trade or business located in an enterprise zone.
The loan is made to a trade or business located solely within an enterprise zone.
The money loaned is used strictly for the business activities within the enterprise zone.
The lender has no equity or other ownership interest in the trade or business.
The loan was made after the enterprise zone was designated.
   Deduction Amount
   California

Net interest means the full amount of the interest, less any direct expenses incurred in making the loan.

Record Keeping

California

FTB publication describes required record keeping as at least the following:
The identity and location of the borrowing trade or business.
The amount of loan, interest earned, and direct expenses associated with the loan.
The use of the loan.

The following discussion describes how the above requirements are addressed in one embodiment of the invention.

Loan Systems

In one embodiment of the invention, loans from two systems of record are processed for filing, as follows. It should be appreciated that the labels, BBD and AFS, of the two systems are by way of example only and do not limit the invention. It should further be appreciated that the number of physical systems is also by way of example and is not meant to be limiting, for example, one embodiment of the invention can contain one loan system of record.

1. BBD: Business Banking Direct maintains a reporting server containing their customer lines of credit and credit card accounts. BDD customers are generally small businesses with less than five million dollars in annual sales. The products as well as relevant account data are relatively simple in structure.
Interest income is derived simply from average outstanding balance and interest rate whose fluctuation is minimal.
Most BDD customers have only one location from which to use the funds.
All products in the system are exclusively for business use.
All relevant monthly data for an account is contained in one record

2. AFS: Commonly referred to as the bank's commercial banking loan system, AFS contains loans and lines of credit that are more complex in structure and pricing.
Interest income is derived from average outstanding balance and interest rates that are subject to daily fluctuations. More importantly, net interest income contains numerous components beyond balance and interest rate.
AFS customers vary from single location small businesses to multinational corporations.
Some loans are structured for use other than the business in account location.

AFS Net Interest Income Components: The following Table C describes the summation of income components that lead to Net Interest Income.

TABLE C

| Component | Calculation By | CRAAFS |
|---|---|---|
| Interest income (+) | AFS | Included. |
| Yield Fees (+) | Profit Max (Wholesale | Included. |
| | Only) | |
| Prepayment Fees (+) | Profit Max (Wholesale | Not included |
| | Only) | due to abnormal amounts |
| | | for some qualifying loans. |
| Cost of Funds (−) | Average COF ratio | Included |
| | used. | |
| Equity Funding | Profit Max (Wholesale | Included |
| Benefit (+) | Only) | |
| Sales & Marketing | Profit Max (Wholesale | Not included |
| Costs (−) | Only) | per Corporate Accounting. |

Yield fees and Prepayment fees are widely considered components of net interest income (a.k.a. Net on Funds) since they may be interchanged with incremental additions to interest rate during the structuring of a loan.
Equity Funding Benefit is a positive income generated from using the bank's own capital to fund balances. It may also be considered a reduction in cost of funds.

Before the above net interest income deduction can be actualized by the loan office, the income amount is subject to factored variables that reduce the dollar amount:
State Tax rate
Federal tax rate to adjust for deduction of federal taxes for state taxes paid
Bank's CA tax

Product Attributes: Table D below describes the inclusion and exclusion of product types based on AFS account coding.

TABLE D

| Attributes | NOTE | CRAAFS |
|---|---|---|
| Loan products with | Interest income calculated | Included. |
| outstanding | | |
| balances but without interest | using average interest rate of | |
| income: i.e., Purchasing Card | similar product group. | |
| Lines of Credit | KPMG advised to include. | Included. |
| Small Real Estate Loans | Excluded loans for condos & | Excluded. |
| possibly for personal use. | 1-4 SFR. | |
| RE Investment Trust | REIT with use of General | Excluded. |
| | Ledger ID: 239, 241, | |
| | 243, 245. | |
| Loans for Securities purchase. | Excluded loans with | Excluded. |
| | PURPOSE_CODE: 130-131. | |
| Personal or Consumer Loans | Excluded loans with | Excluded. |
| in AFS | PURPOSE_CODE: 200-230. | |

Loan Address

BDD system provides one address for loans whose funds are presumed to be in use only in that one location.

AFS accounts usually have only one address as well. In order to maximize the number of qualified loans and to minimize loans that are erroneously qualified, the following address substitutions are incorporated in CRAAFS.

When the primary AFS account address record does not have a valid address or has only a PO BOX, then the following list of addresses become substitutions for mapping to EZs. These addresses are processed in the below order only until a valid address is found.
1. AFS alternate addresses exist at a customer number level. Multiple accounts (or notes) may exist for one customer number. When the note level address is invalid, the alternate credit address for the same customer is used.
2. WICS (Wholesale Integrated Customer System) is designed to integrate accounts in various product systems and belonging to the same customer relationship, into
a system that house all customer data under one identifier. A valid WICS address is mapped to EZs and overrides the invalid loan address.
Because WICS contains addresses from numerous product systems, the override of invalid address is performed joined by WICS identifier) using a logic that favors the most accurate address substitution.
First, the primary credit origination address (for customer relationships with multiple credit customer numbers) is the most favored.
Second, the address of treasury management account is selected.
Third, the address of trade services account is selected.
Fourth, the address of any other commercial banking product account is selected.

Even when the primary AFS account or one of the above substitute address record is a valid address, property (collateral) addresses for real estate loans override the loan origination address for filing. One embodiment of the invention contains commercial banking prospect systems that contains property addresses. The majority of real estate loans have invalid or incomplete property addresses in the systems, and therefore, addresses override loan origination address only when qualified as in EZ.

AFS Address Substitution Result:

Table E is an example table, the T_ADDR_OBLIGOR table in CRAAFS that contains the end result of address substitutions, using 2002 yearend data:

TABLE E

| CUST_ADDR_TYPE | | # Total | Poss | # Qual | Net |
|---|---|---|---|---|---|
| field | Source | Notes | Benefit | Notes | Benefit |
| CLEAN | Notes level AFS address | 72,498 | 7,753,221 | 5011 | 654,408 |
| CLEAN AFSALT | AFS Alternate Address | 438 | 39,336 | 7 | 681 |
| CLEAN WICSAFS | WICS primary credit relationship addr | 3,167 | 289,048 | 116 | 19,972 |
| CLEAN WBS | WICS treasury mgmt address | 88 | 26,142 | 44 | 19,796 |
| CLEAN LCS | WICS trade services address | 21 | 1,614 | 13 | 1614 |
| CLEAN INV | WICS investments address | 3 | 1,141 | 3 | 1141 |
| CLEAN LEA | WICS leasing address | 2 | 61 | 2 | 61 |
| CLEAN RTSN | WICS retail treasury mgmt address | 1 | 0 | 0 | 0 |
| CLEAN PIPE | WICS Pipeline collateral address | 17 | 383 | 2 | 187 |
| CLEAN LOAN MGR | WICS Loan Manager collateral addr | 0 | 0 | 0 | 0 |
| POB | Post Office Box address | 4,430 | 337,835 | | |
| NULL value | Invalid address | 506 | 39,921 | | |

POB and Null Addresses represent a substantial number of loans that cannot be mapped to an EZ.

Address Matching Supplement

It should be appreciated that along with loan addresses matched by CRAAFS, addresses matched by other means, such as manually can be included for filing in subsequent years.

System Overview

The following describes the monthly system process according to one embodiment of the invention.

Data Source

Raw data extracts from AFS and BBD Oracle servers are loaded into the CRAAFS database in the a MS SQL server, referred to herein as WHSLFIN01 (Wholesale Finance).

The programming for the data migration is contained in Data Transformation Service (DTS) packages.

WHSLFIN01 SQL server contains several other databases required for monthly processing, as follows.
PMAX: Profit Max data is migrated from its production Oracle database, by Wholesale Finance on a monthly basis around the 22^{nd} business day of every month for the prior month's account data.
ORGDB: Controller's Organization Database contains general ledger organizational data required by CRAAFS to roll up benefit from AU up to entity levels. This database is updated monthly by the 3^{rd} business day.
WRDB: Wholesale Relationship Database contains a convenient table that describes the bank's organizational rollup from AU to district, division, & group, required by CRAAFS for office reporting.

Profit Max is the only source of several revenue components included in filing: equity funding benefit, interest income related yield fees, and prepayment fees. For this reason, CRAAFS processing is delayed by a full month.

Data Processing.

Once the data has been migrated, they are stamped with a date and retained in their original data content and form. From this point, the CRAAFS monthly or annual process may be run and rerun at any time for any given period, which allows for historic data to be reprocessed with any change in methodology or tax factor components, i.e. state apportionment rate and federal tax rate.

By executing preprogrammed stored procedures:
Address information is gathered, scrubbed, and matched to zone address ranges.
Master tables for each of the system (contains summary information) are appended and updated with relevant data on a monthly basis.
For AFS loans, a details table is also appended and updated with additional profitability and loan attributes data.

Separate stored procedures exist for monthly and for yearend data processing.

### SYSTEM MAINTAINENCE

Every three years: reference tables beginning with T_REF_ADDR_contain data used to scrub address information. Such tables should be updated with new forms of unconventional address components and spelling errors entered by bank data entry clerks.
T_REF_ADDR_CHAR
T_REF_ADDR_CITY_CLEANUP
T_REF_ADDR_NAME
T_REF_ADDR_REPLACE
T_REF_ADDR_STATE
T_REF_ADDR_SUF
T_REF_ADDR_UNIT

Annually: the below data are contained in reference tables beginning with T_EZ or T_REF. In most cases, each record contains a PERIOD field that contains the year in which the data is applicable; such allows for prior years to be restated due to change in information:
EZ & TEA address ranges;
EZ &TEA address ranges;
New and expired EZ dates;
Average COF and int Inc rates;
Entity Nexus;
Bank tax rates & state apportion rates; and
State sales tax rates (Fixed Assets only).

T_EZ_ADDRESSES: contains one record for every street range listed in the state website.

T_EZ_DATA: contains one record for every zone and includes zone designation and expiration date.

T_REF_BENEFIT_RATE: contains one record for every state (program) and period and includes average COF & income rates, as well as variable factors to account for state apportionment & federal deduction.

T_REF_ENTITY_NEXUS_HISTORY: contains one record for every state (program), period, and entity that is to be included in filing. The lack of a record for a given bank entity in a specific period and state signifies that the entity is not included in filing.

Record Keeping Tables

For both AFS and BDD loans, the tables ending in MASTER contain most if not all data required for simple reporting.
T_BASE_OBLIGOR_MASTER
T_BDD_LINES_MASTER

The following should be appreciated:
It is essential to understand that only those records whose QUAL_FLAG field containing “Y” are for loans that are included in filing.
T_BASE_OBLIGOR_MASTER contains one record for every note of a loan in AFS regardless of whether it is qualified or located in zone.
T_BDD_LINES_MASTER contains one record for every loan for every year of activity, that is located in a zone, whether it is qualified or not. Not all loans are included in the table due to the extremely large number of active loans. Such table contains loans that are in zone but do not qualify due to origination date, for example.
Both tables contain a NET_BENEFIT field that contains the actual benefit dollars to the office, after reduction for federal deduction of state taxes paid, if and only if QUAL_FLAG is Y. If QUAL_FLAG is not Y, the amount represents what the benefit amount would be if the loan were qualified.

T_BASE_OBLIGOR_PROFIT contains for every loan in every period, profitability components that contribute to NET_BENEFIT such as AVGOUTSTANDINGBAL, INTERESTINCOME, YIELD_FEES, EQUITYFUNDBEN. It also contains several fields also found in the obligor master table such as QUAL_FLAG, ZONE_ID.

T_ADDR_OBLIGOR contains the note level address of the loan where a valid address was originally available in AFS or the overriding substitute address as described above.

T_ADDR_LINES contains the account address of every active BDD loan.

Following are example tables according to one embodiment the invention.

T_BASE_OBLIGOR_MASTER

| | | MS SQL | | ALLOW | | |
|---|---|---|---|---|---|---|
| PK | COLUMN NAME | DATA TYPE | LENGTH | NULL | CONTENT | DEFINITION |
| 1 | PERIOD | char | 10 | | YYYYMM or YYYYYE | Monthly period or Year |
| | | | | | e.g. “200211” or | End period or record |
| | | | | | “2002YE” | |
| 1 | OBLIGOR | decimal | 9 | | Up to 10-digit | AFS Obligor |
| | | | | | integer | (MCD01CUST_FAC) |
| | | | | | | Number |
| 1 | OBLIGATION | decimal | 9 | | Up to 6-digit integer | AFS Obligation |
| | | | | | | (MC015OBGN_NUM) |
| | | | | | | Number |
| 1 | HLAOBLIGOR | decimal | 9 | | Up to 10-digit | AFS Highest Level |
| | | | | | integer | Advised Obligor |
| | | | | | | (MC010CUST_NUM) |
| 1 | HLAOBLIGATION | decimal | 9 | | Up to 6-digit integer | AFS Highest Level |
| | | | | | | Advised Obligation |
| | | | | | | (MCD02FAC_NUM) |
| 1 | QUAL_FLAG | nvarchar | 5 | 1 | “Y” or NULL | Filing Qualified Flag |
| | ZONE_ID | nvarchar | 10 | 1 | Zone Identifier | Zone identifier |
| | | | | | when address in EZ | |
| | ZONE_STATUS | nvarchar | 10 | 1 | Description of | Zone qualification |
| | | | | | exclusion status | status for loan |
| | ZONE_MAP1 | nvarchar | 10 | 1 | “CRA” or NULL | Mapped by CRAAFS |
| | | | | | | indicator |
| | ZONE_MAP2 | nvarchar | 10 | 1 | “AA” or NULL | Mapped by Arthur |
| | | | | | | Anderson indicator |
| | ZONE_MAP3 | nvarchar | 10 | 1 | “MT” or NULL | Mapped by Mintax |
| | | | | | | indicator |
| | ZONE_MAP4 | nvarchar | 10 | 1 | “ACCT” or NULL | Mapped by Corp. |
| | | | | | | Accounting indicator |
| | CUSTOMER_ID | decimal | 9 | 1 | Up to 7-digit integer | WICS (PMAX) |
| | | | | | | Customer Identifier |
| | WICS_NAME | nvarchar | 90 | 1 | Customer Name | WICS (PMAX) |
| | | | | | | Customer Name |
| | PMAX_FLAG | nvarchar | 10 | 1 | NOT IN USE | |
| | AU | decimal | 5 | 1 | Up to 5-digit integer | Bank GL Accounting |
| | | | | | | Unit |
| | GROUP_ID | decimal | 5 | 1 | Up to 3-digit integer | Bank GL Group |
| | | | | | | Identifier |
| | OFFICER_ID | varchar | 5 | 1 | Up to 5-digit | Wholesale Bank |
| | | | | | alphanumeric char | relationship Officer ID |
| | OFFICER_NAME | varchar | 40 | 1 | Relationship Officer | Relationship Officer |
| | | | | | Name | Name |
| | SUBPRODUCTID | varchar | 3 | 1 | NOT IN USE | Profit MAX |
| | | | | | | Subproduct Identifier |
| | HLAINACTIVEDATE | decimal | 5 | 1 | NOT IN USE | Date of HLA Obligor |
| | | | | | | Inactivity |
| | HLACUSTOBLIGOR | decimal | 9 | 1 | NOT IN USE | Highest Level |
| | | | | | | Advised Customer |
| | | | | | | Obligor Inactivity |
| | HLACUSTINACTIVEDATE | decimal | 5 | 1 | NOT IN USE | Date of HLA Cust |
| | | | | | | Obligor Inactivity |
| | NET_BENEFIT | decimal | 9 | 1 | Dollar amount to | Net Tax Benefit after |
| | | | | | two decimal places. | fed deductions |
| | ENTITY | nvarchar | 5 | 1 | Up to 3-digit integer | Entity Code |

T_BASE_OBLIGOR_PROFIT

| | | DATA | | ALLOW | | |
|---|---|---|---|---|---|---|
| PK | COLUMN NAME | TYPE | LENGTH | NULL | CONTENT | DEFINITION |
| 1 | PERIOD | char | 6 | | YYYYMM or YYYYYE | Monthly period or Year |
| | | | | | e.g. “200211” or | End period or record |
| | | | | | “2002YE” | |
| 1 | OBLIGOR | decimal | 9 | | Up to 10-digit | AFS Obligor |
| | | | | | integer | (MCD01CUST_FAC) |
| | | | | | | Number |
| 1 | OBLIGATION | decimal | 9 | | Up to 6-digit integer | AFS Obligation |
| | | | | | | (MC015OBGN_NUM) |
| | | | | | | Number |
| 1 | HLAOBLIGOR | decimal | 9 | | Up to 10-digit | AFS Highest Level |
| | | | | | integer | Advised Obligor |
| | | | | | | (MC010CUST_NUM) |
| 1 | HLAOBLIGATION | decimal | 9 | | Up to 6-digit integer | AFS Highest Level |
| | | | | | | Advised Obligation |
| | | | | | | (MCD02FAC_NUM) |
| | QUAL_FLAG | nvarchar | 5 | 1 | “Y” or NULL | Filing Qualified Flag |
| | AU | nvarchar | 7 | 1 | Up to 5-digit integer | Bank GL Accounting |
| | | | | | | Unit |
| | ENTITY | nvarchar | 5 | 1 | Up to 3-digit integer | Entity Code |
| | ZONE_ID | nvarchar | 10 | 1 | Zone Identifier | Zone identifier |
| | | | | | When address in EZ | |
| | SUBPRODUCTID | varchar | 3 | 1 | 3-digit | Profit Max |
| | | | | | alphanumeric | Subproduct Identifier |
| | HLACUSTOBLIGOR | decimal | 9 | 1 | Up to 10-digit | Highest Level |
| | | | | | integer | Advised Customer |
| | | | | | | Obligor Inactivity |
| | MC092_CNV_ORIG_EFF_DT | datetime | 8 | 1 | Timestamp | Original Effective |
| | | | | | | Date for loans |
| | | | | | | converted from |
| | | | | | | premerger legacy |
| | | | | | | Systems. |
| | MC071_ORG_EFF_DT | datetime | 8 | 1 | Timestamp | Original Effective |
| | | | | | | Date for loans opened |
| | | | | | | in current AFS. |
| | ORIGEFFECTIVEDATE | datetime | 8 | 1 | Timestamp | Profit Max Original |
| | | | | | | Effective Date. |
| | FCD18_BANK_BAL | decimal | 9 | 1 | Dollar amount to | Average Outstanding |
| | | | | | two decimal places. | Balance |
| | AVGOUTSTANDINGBAL | decimal | 9 | 1 | Dollar amount to | Profit Max Average |
| | | | | | two decimal places. | Outstanding Balance |
| | COFRATE | decimal | 5 | 1 | Number to five | Profit Max Cost of |
| | | | | | decimal places | Funds rate specific to |
| | | | | | | loan |
| | IH602_EARN_YTD | decimal | 9 | 1 | Dollar amount to | AFS Interest Income |
| | | | | | two decimal places. | Earned Year to Date |
| | FH695_DEF_INC | decimal | 9 | 1 | Dollar amount to | AFS Deferred Income |
| | | | | | two decimal places. | for given PERIOD |
| | HLA_LOAN_COUNT | decimal | 9 | 1 | NOT IN USE | Number of notes |
| | | | | | | under HLAOBLIGOR |
| | HLA_AVGOUTSTANDINGBAL | decimal | 9 | 1 | Dollar amount to | Total Average |
| | | | | | two decimal places. | Outstanding Balance |
| | | | | | | for all notes under |
| | | | | | | HLAOBLIGOR |
| | HLA_PORTION | float | 8 | 1 | Number to | Ratio of Avg Balance |
| | | | | | seventeen decimal | from Note to |
| | | | | | places | HLAOBLIGOR |
| | NOF | decimal | 9 | 1 | Dollar amount to | Profit Max Net On |
| | | | | | two decimal places. | Funds |
| | NOFANNUAL | decimal | 9 | 1 | Dollar amount to | Profit Max estimated |
| | | | | | two decimal places. | or actual Annual Net |
| | | | | | | On Funds |
| | HLA_INTERESTINCOME | decimal | 9 | 1 | Dollar amount to | Profit Max Total |
| | | | | | two decimal places. | Interest Income for |
| | | | | | | HLAOBLIGOR |
| | INTERESTINCOME | decimal | 9 | 1 | Dollar amount to | Profit Max Interest |
| | | | | | two decimal places. | Income |
| | YIELDFEES | decimal | 9 | 1 | Dollar amount to | Profit Max Yield Fees |
| | | | | | two decimal places. | |
| | COF | decimal | 9 | 1 | Dollar amount to | Profit Max Cost of |
| | | | | | two decimal places. | Funds |
| | INTFEERECEIVABLE | decimal | 9 | 1 | Dollar amount to | Profit Max Interest |
| | | | | | two decimal places. | Fee Receivable |
| | INTERESTLOSS | decimal | 9 | 1 | Dollar amount to | Profit Max Interest |
| | | | | | two decimal places. | Loss |
| | PRIMECAPREVERSALS | decimal | 9 | 1 | Dollar amount to | Profit Max Prime Cap |
| | | | | | two decimal places. | Reversals |
| | PREPAYFEES | decimal | 9 | 1 | Dollar amount to | Profit Max |
| | | | | | two decimal places. | Prepayment Fees |
| | EQUITYFUNDBEN | decimal | 9 | 1 | Dollar amount to | Profit Max Equity |
| | | | | | two decimal places. | Funding Benefit |
| | NET_INTINCOME | decimal | 9 | 1 | Dollar amount to | Net Interest Income |
| | | | | | two decimal places. | including select Fees |
| | STATE | varchar | 2 | 1 | Two letter state | Address State of loan |
| | | | | | abbreviation. | as found in |
| | | | | | | T_ADDR_OBLIGOR |
| | NET_BENEFIT | decimal | 9 | 1 | Dollar amount to | Net Tax Benefit after |
| | | | | | two decimal places. | fed deductions |

T_BDD_LINES_MASTER

| | | DATA | | ALLOW | | |
|---|---|---|---|---|---|---|
| PK | COLUMN NAME | TYPE | LENGTH | NULL | CONTENT | DEFINITION |
| 1 | PERIOD | nvarchar | 6 | | YYYY, e.g. “2002” | Year of record |
| 1 | ACCT_KEY | nvarchar | 20 | | 17-digit integer | Account Number |
| 1 | ACCT_CONTINUOUS | nvarchar | 20 | | 17-digit integer | Account Number prior |
| | | | | | | to any change |
| | ENTITY | nvarchar | 5 | 1 | Up to 3-digit integer | Entity Code |
| | GROUP_ID | nvarchar | 5 | 1 | Up to 3-digit integer | Bank GL Group |
| | | | | | | Identifier |
| | MO_ACTIVE | nvarchar | 10 | 1 | “Y” (condition of | Active account flag |
| | | | | | data extract) | |
| | MO_BLD_STA | nvarchar | 10 | 1 | 2-digit | BDD account status |
| | | | | | alphanumeric | code. |
| | MO_RAU | nvarchar | 10 | 1 | Up to 5-digit integer | Bank GL Accounting |
| | | | | | | Unit |
| | MO_PRODUCT | nvarchar | 255 | 1 | 3-letter alpha | BDD product code |
| | | | | | character | |
| | MO_CR_LINE | float | 8 | 1 | Dollar amount to | Credit line amount |
| | | | | | one decimal place | |
| | MO_BALANCE | float | 8 | 1 | Dollar amount to | Average monthly |
| | | | | | various decimal | balance |
| | | | | | places | |
| | MO_PRODUCTCODE | nvarchar | 10 | 1 | 3-letter alpha | BDD product code |
| | | | | | character | (same as |
| | | | | | | MO_PRODUCT) |
| | ACCT_CHAIN | nvarchar | 20 | 1 | Up to 3-digit integer | Account Chain |
| | | | | | | (customer number) |
| | ACCT_LAST_DATE | smalldatetime | 4 | 1 | Timestamp | Account last active |
| | | | | | | date (as of data |
| | | | | | | extraction date) |
| | ACCT_COMPANY | nvarchar | 50 | 1 | Company name | Company name |
| | ACCT_HOLDER | nvarchar | 50 | 1 | Account holder | Account holder name |
| | | | | | name | |
| | ACCT_ZIP | nvarchar | 10 | 1 | 5-digit US Postal | ZIP code account |
| | | | | | ZIP | location |
| | ACCT_FIRST_CR | float | 8 | 1 | Dollar amount to | First (opening) credit |
| | | | | | one decimal place | line amount |
| | ACCT_RATECODE | nvarchar | 10 | 1 | One digit numeric | BDD interest rate |
| | | | | | | code |
| | ACCT_OPEN | smalldatetime | 4 | 1 | Timestamp | Date account opened |
| | ACCT_BLD | nvarchar | 10 | 1 | “D”, “L”, “N” or | UNDEFINED |
| | | | | | NULL | |
| | ACCT_SSN | nvarchar | 15 | 1 | 10-digit integer | Business tax identifier |
| | | | | | | or account holder |
| | | | | | | social security |
| | | | | | | number |
| | ACCT_SIC_CODE | nvarchar | 10 | 1 | 2-digit integer | Primary two digit |
| | | | | | | standard industry |
| | | | | | | code |
| | ACCT_CRA_CODE | nvarchar | 15 | 1 | 2-digit integer | Community |
| | | | | | | Reinvestment Act |
| | | | | | | code |
| | ACCT_BRANCH_AU | nvarchar | 10 | 1 | 4-digit integer | Bank GL branch |
| | | | | | | accounting unit |
| | ACCT_CITY | nvarchar | 50 | 1 | City | Account location city |
| | ACCT_STATE | nvarchar | 10 | 1 | 2-digit alpha | Account location |
| | | | | | character for US | state |
| | | | | | states | |
| | ACCT_ADDR1 | nvarchar | 50 | 1 | Address | Address line account |
| | | | | | | location |
| | ACCT_BUS_PHONE | nvarchar | 15 | 1 | 10-digit integer | Account Business |
| | | | | | | Phone number |
| | TMS_PURCH_DOL | float | 8 | 1 | Dollar amount to | Total positive |
| | | | | | various decimal | purchase amount |
| | | | | | places | |
| | TMS_NET_PURCH_DOL | float | 8 | 1 | Dollar amount to | Net Purchase amount |
| | | | | | one or two decimal | |
| | | | | | places | |
| | TMS_FINANCE_FEES | float | 8 | 1 | Dollar amount to | Finance Fees |
| | | | | | various decimal | (Interest Income) |
| | | | | | places | |
| | TMS_FINANCE_CNT | float | 8 | 1 | Positive or negative | UNDEFINED |
| | | | | | integer to one | |
| | | | | | decimal place | |
| | QUAL_FLAG | nvarchar | 5 | 1 | “Y” or NULL | Filing Qualified Flag |
| | ZONE_ID | nvarchar | 10 | 1 | Zone Identifier | Zone identifier |
| | | | | | when address in EZ | |
| | ZONE_STATUS | nvarchar | 10 | 1 | Description of | Zone qualification |
| | | | | | exclusion status | status for loan |
| | NET_BENEFIT | float | 8 | 1 | Dollar amount to | Net Tax Benefit after |
| | | | | | two decimal places. | fed deductions |

T_ADDR_OBLIGOR

| | | MS SQL | | | | |
|---|---|---|---|---|---|---|
| | | DATA | | ALLOW | | |
| PK | COLUMN NAME | TYPE | LENGTH | NULL | CONTENT | DEFINITION |
| 1 | PERIOD | char | 6 | | YYYYMM or YYYYYE e.g. | Monthly period or Year |
| | | | | | “200211” or “2002YE” | End period of record |
| 1 | MCD01_CUST_FAC | decimal | 9 | | Up to 10-digit integer | AFS Obligor |
| | | | | | | (MCD01CUST_FAC) |
| | | | | | | Number |
| 1 | MCD02_FAC_NUM | decimal | 9 | | Up to 6-digit integer | AFS Highest Level |
| | | | | | | Advised Obligation |
| | | | | | | (MCD02FAC_NUM) |
| 1 | MC010_CUST_NUM | decimal | 9 | | Up to 10-digit integer | AFS Highest Level |
| | | | | | | Advised Obligor |
| | | | | | | (MC010CUST_NUM) |
| 1 | MC015_OBGN_NUM | decimal | 9 | | Up to 6-digit integer | AFS Obligation |
| | | | | | | (MC015OBGN_NUM) |
| | | | | | | Number |
| | CUSTOMER_ID | int | 4 | 1 | Up to 7-digit integer | WICS (PMAX) |
| | | | | | | Customer Identifier |
| | CUST_NAME | varchar | 30 | 1 | Customer Name | WICS ((PMAX) |
| | | | | | | Customer Name |
| | ZONE_ID | varchar | 10 | 1 | Zone Identifier when | Zone identifier |
| | | | | | address in EZ | |
| | CUST_ADDR_TYPE | varchar | 30 | 1 | “CLEAN” valid address, | Address Type |
| | | | | | “POB”: post office box, or | |
| | | | | | Null no valid address | |
| | CUST_ADDR_NUM | varchar | 30 | 1 | Integer | Street Address Number |
| | CUST_ADDR_DIR | varchar | 30 | 1 | “N”, “S”, “E”, “W” | Street Address Direction |
| | CUST_ADDR_NAME | varchar | 40 | 1 | Street Name | Street Name |
| | CUST_ADDR_SUF | varchar | 30 | 1 | “STREET”, “AVENUE”, etc | Street Suffix |
| | CUST_ADDR_UNIT | varchar | 30 | 1 | Number or letter of building | Street Address Unit |
| | | | | | unit | |
| | CUST_ADDR_1 | varchar | 40 | 1 | Street address where | First valid address from |
| | | | | | ADDR_TYPE = “CLEAN” | ADDR1 through ADDR6 |
| | CUST_ADDR1 | varchar | 30 | 1 | Address, Notes or NULL | Street Address Line 1 |
| | CUST_ADDR2 | varchar | 30 | 1 | Address, Notes or NULL | Street Address Line 2 |
| | CUST_ADDR3 | varchar | 30 | 1 | Address, Notes or NULL | Street Address Line 3 |
| | CUST_ADDR4 | varchar | 30 | 1 | Address, Notes or NULL | Street Address Line 4 |
| | CUST_ADDR5 | varchar | 30 | 1 | Address, Notes or NULL | Street Address Line 5 |
| | CUST_ADDR6 | varchar | 30 | 1 | Address, Notes or NULL | Street Address Line 6 |
| | CUST_CITY | varchar | 30 | 1 | City | City |
| | CUST_ZIP | varchar | 12 | 1 | ZIP Code | ZIP Code |
| | STATE | varchar | 2 | 1 | 2 digit alphabetical characters | State |
| | | | | | for US states | |
| | COUNTY | varchar | 25 | 1 | NOT IN USE | County |
| | ZIP3 | varchar | 3 | 1 | ZIP Code | First 3-digits of ZIP Code |
| | ZIP4 | varchar | 4 | 1 | ZIP Code | First 4-digits of ZIP Code |

T_ADDR_LINES

| | | DATA | | ALLOW | | |
|---|---|---|---|---|---|---|
| PK | COLUMN NAME | TYPE | LENGTH | NULL | CONTENT | DEFINITION |
| | PERIOD | char | 6 | 1 | YYYYMM e.g. “200211” | Monthly period of record |
| | SOURCE_ID | nvarchar | 15 | 1 | 17-digit integer | Primary identifier (ACCT_KEY) of |
| | | | | | | source system (BDD) |
| | SOURCE_ID2 | varchar | 15 | 1 | 17-digit integer | Primary identifier |
| | | | | | | ACCT_CONTINUOUS) of source |
| | | | | | | system (BDD) |
| | SOURCE_SYSTEM | varchar | 30 | 1 | “BDD” | Source System |
| | SOURCE_NAME | varchar | 50 | 1 | Company Name | Name of account in source system |
| | ZONE_ID | varchar | 10 | 1 | Zone Identifier | Address Zone |
| | ADDR_TYPE | varchar | 30 | 1 | “CLEAN”: valid address | Address Type |
| | | | | | “POB”: post office box | |
| | | | | | Null: no valid address | |
| | ADDR_NUM | varchar | 30 | 1 | Integer | Street Address Number |
| | ADDR_DIR | varchar | 30 | 1 | “N”, “S”, “E”, “W” | Street Address Direction |
| | ADDR_NAME | varchar | 40 | 1 | Street Name | Street Name |
| | ADDR_SUF | varchar | 30 | 1 | “STREET”, “AVENUE”, etc | Street Suffix |
| | ADDR_UNIT | varchar | 30 | 1 | Number or letter of | Street Address Unit |
| | | | | | building unit | |
| | ADDR_1 | varchar | 40 | 1 | Street address where | First valid address from ADDR1 |
| | | | | | ADDR_TYPE = “CLEAN” | through ADDR6 |
| | ADDR1 | varchar | 40 | 1 | Address, Notes, or NULL | Street Address Line 1 |
| | ADDR2 | varchar | 40 | 1 | Address, Notes, or NULL | Street Address Line 2 |
| | ADDR3 | varchar | 40 | 1 | Address, Notes, or NULL | Street Address Line 3 |
| | ADDR4 | varchar | 40 | 1 | Address, Notes, or NULL | Street Address Line 4 |
| | ADDR5 | varchar | 40 | 1 | Address, Notes, or NULL | Street Address Line 5 |
| | ADDR6 | varchar | 40 | 1 | Address, Notes, or NULL | Street Address Line 6 |
| | CITY | varchar | 30 | 1 | City | City |
| | ZIP | varchar | 12 | 1 | ZIP Code | ZIP Code |
| | STATE | varchar | 2 | 1 | 2 digit alphabetical | State |
| | | | | | characters for US states | |
| | COUNTY | varchar | 25 | 1 | NOT IN USE | County |
| | ZIP3 | varchar | 3 | 1 | ZIP Code | First 3-digits of ZIP Code |
| | ZIP4 | varchar | 4 | 1 | ZIP Code | First 4-digits of ZIP Code |
| | OFFICE | varchar | 20 | 1 | NOT IN USE | Bank Office |
| | CENSUS_FIPS | nvarchar | 20 | 1 | NOT IN USE | US Census Tract Code |

An Exemplary Embodiment—Employee Hiring Credit Methodology

It should be appreciated that the following discussion is meant by way of example only and that other embodiments and variations are within the spirit and scope of the invention. For example, the following discussion focuses on the state of California, but it is readily apparent that modifications and adjustments made to accommodate other states are well within the scope and spirit of the invention. Also, the discussion employs names for specific systems and tables, but it should be appreciated that such labels are also by way of example and are by no means meant to be limiting.

It should further be appreciated that one embodiment of the invention contains a system referred to as CRAAFS which performs the automatic scrubbing and address matching functionality and such reference is by way of example only, for ease of reading and understanding, and does not in any way limit the invention.

Employee Wage Credit

Qualifications

California

The 2001 FTB Publication-1047 specifies that an employee must be employed in an Enterprise Zone location at least 50% of the time and must meet at least one of fourteen qualification criteria. Based on data available at the time of this documentation, only four criteria could be assessed for matching:
Resident of a Targeted Employment Area (TEA) during the period of filing;
Vietnam veteran;
Disabled veteran; and
Native American.

The vast majority of qualifiable employees meet the criteria of residing in TEA. Street address information for each TEA is available on individual zone websites. The TEA designation is as follows:
Twenty-two out of thirty-nine zones listed TEA streets in a separate file from the EZ street listing.
West Sacramento simply lists all of zip code 95605 as TEA
Some zones (Cochella, Lindsay) do not list TEA streets and instead simply report that 95% of residents in the cities live in TEA. In such cases, all residents of those cities were considered TEA residents.
Some zones state that TEA and EZ are one and the same. And some zones do not mention TEA at all. In these cases, EZ street listings were used in lieu of TEA to qualify employees.
   Credit Amount
   California

Credit amount is calculated by multiplying the number of hours worked during the year by the lesser of actual hourly wage or 150% of state minimum wage. One hundred percent of employee hours are eligible for tax credit as long as 50% of hours are worked in a zone.

Allowance percentages are applied to the qualifying wage amount for each employee. During the first 12 months of employment, 50% of qualifying rate times the number of total hours may be applied as credit (40% during the second 12 months, 30% in the third, 20% in the fourth, 10% in the fifth, and 0% after the fifth).

A reduction in the above credit by 35% for Federal deduction of state taxes paid, results in the actual net benefit.

Credit Recapture

For employees terminated within the first 270 workdays (roughly one calendar year), for reasons other than misconduct, disability, or reduction in business, the prior year's claim amount must be added back to the current year's tax. Therefore, termination due to failure to perform duties results in the credit to be recaptured or disqualified. Determination of such employee credit is pending data availability.

Based on 2000 data, approximately 70 employees, whose claims equal to $120K in credit, were terminated within such period, for reasons not provided to Corporate Tax.

Record Keeping:

California

The FTB publication describes required record keeping: employee name, hire date, hours worked each month, qualifying hourly rate, total wages per month, and location of job site. All but the two items listed below are gathered and retained:
1. Certification.
Copies of Form TCA EZ1 are required to be kept for each employee claimed for the credit. This form, which is filled by the employee, is supposed to determine qualification.
2. Monthly hours.
Initial data for 2000 filing does include the number of hours worked per month by month. The requirement would detail month-by-month hours on which allowance percentages are applied. CRAAFS calculates the hours for each allowance percentage by using the employee start-date as a marker for when a twelve-month period begins and ends.
   Total Hours Worked

Based on available data, hours worked was calculated by dividing NLGRS_YTD (total pay year to date) by hourly rate.
This total pay amount includes bonuses and will overstate the number hours work (and tax credit) by a percentage equal to the bonus percentage; and
The pay amount does not include contributions to company retirement plans and will understate the number of hours worked by a percentage equal to contributions.
   System Overview
   Data structure

Hiring Credit data process entails the same general steps as found in the process for determining Lender Deductions. Raw data extracts are loaded into server. A master table (contains summary information) and a details table are appended and updated with relevant data.

Address Scrubbing Algorithm

The same algorithm used to scrub address data for Lender Deductions is also used to process employee home, work location, and AU addresses.

Address Matching Algorithm

Work location and AU addresses are matched to EZ using the same algorithm used for Lender Deductions (found in stored procedure SP_ADDR_UPDEZ). In order to accommodate California's inconsistent listing of TEA, a separate algorithm was developed (found in SP_ADDR_UPDEZ_EMPLOYEE)

System Modifications

Employee End-date Derived.

Employee end-date does not exist as a field. In order to correctly bucket hours for the year if the end-date (without the year value) is before the start-date (so that year's hours are not spread to a lower allowance rate) the effective date for any non-paid employment status is used to determine end date.

Applying Past Org Chart to Past Periods.

Prior years' AU address tables is used to determine prior year filings in order to reflect recent AU reassignments.

Record Keeping Tables

For record keeping purposes, four tables contain all required data elements:

T_CRED_EMPL_MASTER
One record for every employee in each year of employment.
QUAL_FLAG, Credit amount, and the means to qualification.
Organizational rollup

T_CRED_EMPL_PAYROLL
Nearly always two records for every employee in each year of employment, each record depicting wage, hours, and credit for two credit schedules (50%, 40%, 30%, 20% or 10%) in a calendar year.

Both tables above contain records for every employee regardless of qualification, as well as the amount of the credit if they were to qualify. A “Y” in the QUAL_FLAG field indicates that all criteria were met for qualification. Credit amount does not include a reduction in amount for federal deduction of state taxes paid.

T_ADDR_EMPLOYEE:
Employee home address

T_ADDR_WORK_LOCATION:
Employee work location address

T_ADDR_AU:
Accounting unit address used only when work location address is invalid.

Following are examples of tables.

T_CRED_EMPL_MASTER

| | | MS SQL | | | | |
|---|---|---|---|---|---|---|
| | | DATA | | ALLOW | | |
| PK | COLUMN NAME | TYPE | LENGTH | NULL | CONTENT | DEFINITION |
| 1 | EMPLID | Float | 8 | | 5 to 6 digit number | Employee Identifier |
| 1 | PERIOD | nvarchar | 4 | | YYYY, e.g. “2002” | Year of record |
| | PERIOD_CRED | decimal | 9 | 1 | Dollar amount rounded to cent. | Amount of qualifiable credit. |
| | STATE | nvarchar | 2 | 1 | 2 digit alphabetical characters | Geographical state of employment |
| | | | | | for US states. | |
| | QUAL_FLAG | nvarchar | 5 | 1 | “Y” or null | Indicates qualification |
| | QUAL_TYPE | nvarchar | 10 | 1 | Null or any combination of the | L: work location in zone |
| | | | | | letters indicating criteria | A: au in zone |
| | | | | | qualified. | T: home in TEA |
| | | | | | | E: ethnicity |
| | | | | | | M: military status |
| | CRED_RECAPT_REASON | nvarchar | 5 | 1 | See contents in | |
| | | | | | T_REF_HR_ACTION_CREDIT_{—} | |
| | | | | | RECAPT | |
| | ZONE_ID | nvarchar | 10 | 1 | Zone identifier | Work location (or AU) Zone |
| | TEA_ZONE_ID | varchar | 10 | 1 | Zone identifier | Home Zone |
| | TEA_ZONE_TYPE | varchar | 10 | 1 | Null or “TEA”, “EZ”, “TEAZIP”, | See Appendix: TEA Designation |
| | | | | | or “TEACITY” | |
| | ORIG_HIRE_DT | Smalldatetime | 4 | 1 | Date | Original Hire Date |
| | EFFDT | Smalldatetime | 4 | 1 | Date | Employee record last update |
| | EMPL_END_DT | Smalldatetime | 4 | 1 | Date | Employment End Date |
| | EMPL_STATUS | nvarchar | 5 | 1 | See T_REF_HR_{—} | Employee Status |
| | | | | | EMPLOYEE_STATUS | |
| | AU | varchar | 10 | 1 | 1 to 5 digit integer | Accounting Unit |
| | ENTITY | nvarchar | 5 | 1 | 3-digit alphanumeric | Entity |
| | GROUP_ID | nvarchar | 5 | 1 | 1 to 3 digit integer | Group Identifier |
| | LOCATION | nvarchar | 5 | 1 | 5-digit number with leading | Work Location Identifier |
| | | | | | zeroes. | |
| | HOURLY_RT | Float | 8 | 1 | Dollar amount. | Employee hourly pay rate |
| | HOURS_YE | Float | 8 | 1 | Year total hours worked | Calculated: PAID_YE/ |
| | | | | | | HOURLY_RT |
| | PAID_YE | decimal | 9 | 1 | Dollar amount rounded to cent. | Year total salary paid including |
| | | | | | | bonuses and excluding amounts |
| | | | | | | contributed to retirement. |
| | NATIONAL_ID | nvarchar | 9 | 1 | Nine digit number | Social Security number |
| | EMPL_NAME | nvarchar | 50 | 1 | Last, First Middle Initial. | Employee Name |
| | DISABLED_VET | nvarchar | 10 | 1 | “Y”, “N” or “U” | Disabled Veteran indicator |
| | ETHNIC_GROUP | nvarchar | 10 | 1 | See T_REF_ETHNIC_GRP | Ethnic Group. See |
| | | | | | | T_REF_ETHNIC_GRP_QUAL |
| | MILITARY_STATUS | nvarchar | 10 | 1 | See T_REF_MILITARY_STAT | Military Status. See |
| | | | | | | T_REF_MILITARY_STAT_{—} |
| | | | | | | QUAL |

T_CRED_EMPL_PAYROLL

| | | DATA | | ALLOW | | |
|---|---|---|---|---|---|---|
| PK | COLUMN NAME | TYPE | LENGTH | NULL | CONTENT | DEFINITION |
| 1 | EMPLID | Float | 8 | | 5 to 6 digit number | Employee Identifier |
| 1 | PERIOD | nvarchar | 4 | | YYYY, e.g. “2002” | Year of record |
| 1 | EMPL_YEAR | Int | 4 | | Integer | Year of employment subject to |
| | | | | | | schedule |
| | PERIOD_PART | Float | 8 | 1 | Decimal less than one | Portion of calendar year which |
| | | | | | | overlaps EMPL_YEAR and is subject |
| | | | | | | to schedule |
| | PERIOD_END | nvarchar | 10 | 1 | “F”: front end | Indicates the front or back end of the |
| | | | | | “B”: back end | calendar year |
| | PERIOD_PART_HRS | decimal | 9 | 1 | Number of hours worked | Number of hours subject to schedule |
| | | | | | in PERIOD_PART | |
| | PERIOD_QUAL_RATE | Float | 8 | 1 | Qualifiable hourly rate | See T_REF_CRED_WAGE |
| | PERIOD_PART_CRED | decimal | 9 | 1 | Dollar amount rounded to | Calculated: PERIOD_PART × PERIOD_{—} |
| | | | | | cent. Qualifiable credit | QUAL_RATE where |
| | | | | | amount. | ORIG_HIRE_DT is qualifiable. |
| | STATE | nvarchar | 2 | 1 | 2 digit alphabetical | Geographical state of employment |
| | | | | | characters for US states | |
| | ORIG_HIRE_DT | smalldatetime | 4 | 1 | Date | Original Hire Date |
| | EFFDT | Smalldatetime | 4 | 1 | Date | Employee record last update |
| | EMPL_END_DT | Smalldatetime | 4 | 1 | Date | Employment End Date |
| | EMPL_STATUS | nvarchar | 5 | 1 | See | Employee Status |
| | | | | | T_REF_HR_EMPLOYEE_{—} | |
| | | | | | STATUS | |
| | AU | varchar | 10 | 1 | 1 to 5 digit integer | Accounting Unit |
| | LOCATION | nvarchar | 5 | 1 | 5-digit number with | Work Location Identifier |
| | | | | | leading zeroes. | |
| | HOURLY_RT | Float | 8 | 1 | Dollar amount. | Employee hourly pay rate |
| | HOURS_YE | Float | 8 | 1 | Year total hours worked | Calculated: PAID_YE/HOURLY_RT |
| | PAID_YE | decimal | 9 | 1 | Dollar amount rounded to | Year total salary paid including |
| | | | | | cent. | bonuses and excluding amounts |
| | | | | | | contributed to retirement. |

It should be appreciated that all three tables, namely such cited hereinbelow, have the exact same structure except for indexing.

T_ADDR_EMPLOYEE (E)
T_ADDR_WORK_LOCATION (W)
T_ADDR_AU (A)

| | | DATA | | ALLOW | | |
|---|---|---|---|---|---|---|
| PK | COLUMN NAME | TYPE | LENGTH | NULL | CONTENT | DEFINITION |
| | PERIOD | char | 6 | 1 | YYYY, e.g. “2002” | Year of record |
| | SOURCE_ID | nvarchar | 15 | 1 | (E): Employee Identifier | |
| | | | | | (W): Location Identifier | |
| | | | | | (A): Accounting Unit | |
| | SOURCE_ID2 | varchar | 15 | 1 | (E): NATIONAL_ID (SSN) | |
| | | | | | (W): Null | |
| | | | | | (A): Entity | |
| | SOURCE_SYSTEM | varchar | 30 | 1 | (E): “HR” | |
| | | | | | (W): “HRWL” | |
| | | | | | (A): “GL” | |
| | SOURCE_NAME | varchar | 50 | 1 | (E): EMPL_NAME | |
| | | | | | (W): Null | |
| | | | | | (A): AU Name | |
| | ZONE_ID | varchar | 10 | 1 | Zone Identifier | Address Zone |
| | ADDR_TYPE | varchar | 30 | 1 | “CLEAN”: valid address | Address Type |
| | | | | | “POB”: post office box | |
| | | | | | Null: no valid address | |
| | ADDR_NUM | varchar | 30 | 1 | | Street Address Number |
| | ADDR_DIR | varchar | 30 | 1 | “N”, “S”, “E”, “W” | Street Address Direction |
| | ADDR_NAME | varchar | 40 | 1 | | Street Name |
| | ADDR_SUF | varchar | 30 | 1 | “STREET”, “AVENUE”, etc | Street Suffix |
| | ADDR_UNIT | varchar | 30 | 1 | Number or letter of | Street Address Unit |
| | | | | | building unit | |
| | ADDR_1 | varchar | 40 | 1 | Street address where | First valid address from ADDR1 |
| | | | | | ADDR_TYPE = “CLEAN” | through ADDR6 |
| | ADDR1 | varchar | 40 | 1 | | Street Address Line 1 |
| | ADDR2 | varchar | 40 | 1 | | Street Address Line 2 |
| | ADDR3 | varchar | 40 | 1 | | Street Address Line 3 |
| | ADDR4 | varchar | 40 | 1 | | Street Address Line 4 |
| | ADDR5 | varchar | 40 | 1 | | Street Address Line 5 |
| | ADDR6 | varchar | 40 | 1 | | Street Address Line 6 |
| | CITY | varchar | 30 | 1 | | City |
| | ZIP | varchar | 12 | 1 | | ZIP Code |
| | STATE | varchar | 2 | 1 | 2 digit alphabetical | State |
| | | | | | characters for US states | |
| | COUNTY | varchar | 25 | 1 | | County |
| | ZIP3 | varchar | 3 | 1 | | First 3-digits of ZIP Code |
| | ZIP4 | varchar | 4 | 1 | | First 4-digits of ZIP Code |
| | OFFICE | varchar | 20 | 1 | Not Used | Bank Office |
| | CENSUS_FIPS | nvarchar | 20 | 1 | | US Census Tract Code |

### REFERENCE TABLE CONTENTS

Following are such example tables.

T_REF_CRED_ALLOWANCE: determines schedule of
wage applicable as credit.

| STATE | PERIOD | EMPL_YEAR | ALLOWANCE |
|---|---|---|---|
| CA | 2000 | 1 | 0.5 |
| CA | 2000 | 2 | 0.4 |
| CA | 2000 | 3 | 0.3 |
| CA | 2000 | 4 | 0.2 |
| CA | 2000 | 5 | 0.1 |
| CA | 2001 | 1 | 0.5 |
| CA | 2001 | 2 | 0.4 |
| CA | 2001 | 3 | 0.3 |
| CA | 2001 | 4 | 0.2 |
| CA | 2001 | 5 | 0.1 |
| CA | 2002 | 1 | 0.5 |
| CA | 2002 | 2 | 0.4 |
| CA | 2002 | 3 | 0.3 |
| CA | 2002 | 4 | 0.2 |
| CA | 2002 | 5 | 0.1 |

T_REF_CRED_WAGE: determines maximum wage applicable
as credit.

| STATE | PERIOD | MIN_WAGE | MAX_RATIO | MAX_CRED |
|---|---|---|---|---|
| CA | 2000 | 5.75 | 1.5 | 8.625 |
| CA | 2001 | 6.25 | 1.5 | 9.375 |
| CA | 2002 | 6.75 | 1.5 | 10.125 |

T_REF_HR_ACTION_CREDIT_RECAPT

| EMPL_STATUS | ACTION_REASON | ACTION_DESCR |
|---|---|---|
| T | JD | DISSATISFIED GENERAL |
| T | OI | OTHER INVOLUNTARY |
| T | OT | OTHER (EXPLAIN) |
| T | PA | POSITION ELIMINATED |
| T | RP | FAILED TO PERFORM |
| | | JOB DUTIES |
| T | ST | SEVERANCE |
| | | TERMINATION |
| T | VQ | NO REASON GIVEN |

T_REF_HR_EMPLOYEE_STATUS: determines employees
who do not qualify for credit, signified by “Y” in EMPL_END field.

| EMPL_STATUS | DESCRIPTION | EMPL_END |
|---|---|---|
| A | Active | |
| D | Deceased | Y |
| L | Leave of Absence | Y |
| P | Leave With Pay | |
| Q | Retired With Pay | |
| R | Retired | Y |
| S | Suspended | Y |
| T | Terminated | Y |
| U | Terminated With Pay | |
| V | Terminated Pension Pay Out | Y |
| X | Retired Pension Administration | Y |

T_REF_HR_ETHNIC_GRP: ethnic groups defined in HR system.

| ETHNIC_CODE | ETHNIC_GROUP |
|---|---|
| 1 | White |
| 2 | Black |
| 3 | Hispanic |
| 4 | Asian/Pacific Islander |
| 5 | American Indian/Alaskan Native |
| 6 | Not Applicable |
| A | Asian/Pacific Islander |
| B | Black |
| C | Caucasian |
| H | Hispanic |
| I | American Indian/Alaskan Native |
| N | White |
| R | Refused |

T_REF_HR_ETHNIC_GRP_QUAL: qualifying
ethnic group by state program.

| ETHNIC_CODE | STATE |
|---|---|
| 5 | CA |
| I | CA |

T_REF_HR_MILITARY_STAT:

| STATUS_CODE | STATUS_NAME |
|---|---|
| 1 | Not Indicated |
| 2 | No Military Service |
| 3 | Vietnam Era Veteran |
| 4 | Other Veteran |
| 5 | Active Reserve |
| 6 | Inactive Reserve |
| 7 | Retired |
| N | No |
| Y | Yes |

T_REF_HR_MILITARY_STAT_QUAL:

| STATUS_CODE | STATE |
|---|---|
| 3 | CA |

Following is an example table showing TEA Designation:

| | | CERT on City |
|---|---|---|
| Zone links available in State website: | TEA Determination | Web Site |
| Agua Mansa (Riverside, Colton, Rialto) | Website reports that TEA zone is | |
| Map \| Colton Website, Riverside Website, | the same as the Enterprise Zone | |
| Riverside County Website \| Streets | | |
| Altadena/Pasadena | TEA Streets listed | |
| Map\|West Altadena Website, Pasadena Website \| | | |
| Streets, | | |
| TEA Streets | | |
| Antelope Valley (Palmdale, Lancaster, Los Angeles | TEA Streets listed | |
| County) | | |
| Map \| Lancaster Website, Palmdale Website | | |
| Streets \| TEA Streets | | |
| Bakersfield | TEA Streets listed | |
| Map \| City Website, County Website \| Streets, TEA | | |
| Streets | | |
| Calexico | TEA Streets listed | Y |
| Map \| Streets, TEA Streets | | |
| Coachella Valley (Coachella, Indio, Thermal) | Website reports that 95% of | |
| Map \| Website \| Streets | residents live in TEA | |
| Delano | Website reports that 90% of | |
| Map \| Website \| Streets | residents live in TEA | |
| Eureka | TEA Streets listed | |
| Map \| Website \| Streets, TEA Streets | | |
| Fresno | TEA Streets listed | |
| Map \|Website \| Streets, TEA Streets | | |
| Kings County (Hanford, Lemoore, Corcoran) | TEA Streets listed | |
| Map \| Website \| Streets, TEA Streets | | |
| Lindsay | Website reports that 95% of | |
| Map \| Website \| Streets | residents live in TEA | |
| Long Beach | EZ Streets utilized | |
| Map \| Website \| Streets | | |
| Los Angeles, Central City | EZ Streets utilized | |
| Map \| Website \| Streets | | |
| Los Angeles, Eastside | EZ Streets utilized | |
| Map \| Website \| Streets | | |
| Los Angeles, Northeast Valley | EZ Streets utilized | |
| Map \| Website \| Streets | | |
| Los Angeles, Mid-Alameda Corridor | EZ Streets utilized | |
| (Los Angeles, Lynwood, Huntington Park, South Gate) | | |
| Map \| Website \| Streets | | |
| Los Angeles, Harbor Area | EZ Streets utilized | |
| Map \| Website \| Streets | | |
| Madera | TEA Streets listed | |
| Map \| Website \| Streets, TEA Streets | | |
| Merced/Atwater | TEA Streets listed | |
| Map \| Merced Website \| Streets, TEA Streets | | |
| Oakland | TEA Streets listed | |
| Map \| Website \| Streets, TEA Streets | | |
| Oroville | TEA Streets listed | |
| Map \| Website \| Streets, TEA Streets | | |
| Pittsburg | TEA same as Enterprise Zone | |
| Map \| Streets | | |
| Porterville | TEA Streets listed | |
| Map \| Streets, TEA Streets | | |
| Richmond | EZ Streets utilized | |
| Map \| Website \| Streets | | |
| Sacramento, Florin Perkins | EZ Streets utilized | |
| Map \| Website \| Streets | | |
| Sacramento, Northgate/Norwood | EZ Streets utilized | |
| Map \| Website \| Streets | | |
| Sacramento, Army Depot | EZ Streets utilized | |
| Map \| Website | | |
| San Diego-San Ysidro/Otay Mesa | TEA Streets listed | |
| Map \| Website \| Streets, TEA Streets | | |
| San Diego-Southeast/Barrio Logan | TEA Streets listed | |
| Map \| Streets, TEA Streets | | |
| San Francisco | TEA Streets listed | Y |
| Map \| Website \| Streets, TEA Streets | | |
| San Jose | TEA Streets listed | |
| Map \| Website \| Streets, TEA Streets | | |
| Santa Ana | TEA Streets file in Santa Ana | |
| Map \| Website \| Streets | Website | |
| Shafter | TEA Streets listed | |
| Map \| Website \| Streets, TEA Streets | | |
| Shasta Metro (Redding, Anderson, Shasta Lake) | TEA Streets listed | |
| Map \| Website \| Streets, TEA Streets | | |
| Shasta Valley (Yreka, Weed, Montague) | TEA same as Enterprise Zone | |
| Yreka map, Weed map, Montague map, Airport map | | |
| Website \| Streets | | |
| Stockton | TEA Streets listed | |
| Map \| Website \| Streets, TEA Streets | | |
| Watsonville | TEA Streets listed | |
| Map \| Streets, TEA Streets | | |
| West Sacramento | TEA Streets link state that TEA | |
| Map \| Website \| Streets, TEA Streets | includes 95605 | |
| Yuba/Sutter (Yuba City, Marysville) | TEA Streets listed | |
| Map \| Website \| Streets, TEA Streets | | |

An Exemplary Embodiment—Sales and Use Credit Methodology

It should be appreciated that the following discussion is meant by way of example only and that other embodiments and variations are within the spirit and scope of the invention. For example, the following discussion focuses on the state of California, but it is readily apparent that modifications and adjustments made to accommodate other states are well within the scope and spirit of the invention. Also, the discussion employs names for specific systems and tables, but it should be appreciated that such labels are also by way of example and are by no means meant to be limiting.

Sales & Use Credit

Qualifications

California

The qualified property type applicable to the bank includes only data processing and communications equipment.

The guideline specifies that the business is located and property is used in an Enterprise Zone

Credit Amount

California

Credit amount is calculated by determining the sales tax rate at the location of the purchaser multiplied by the paid cost of property. Sales tax rates are determined at the county level.

Property purchased in one state but located in another state's Enterprise Zone is not considered qualified.

The credit amount is limited to twenty million dollars of property costs per filing. This limit is not considered by the CRAAFS system in any of its calculations, instead the sales tax rate is provided for each property record, so that if the total property cost limit is exceeded, the filing amount may be based on those items with the highest sales tax paid. Corporate tax will file accordingly, in order to not exceed credit limit, using relevant data: property costs, bank entity, and sales tax rate.

Assets Included:

Peoplesoft System (FA). Data for the vast majority of qualifiable bank purchases are centralized in the Peoplesoft system for fixed assets.
ATM locations. General practice permits an ATM or ATM Center location to be considered the business location. ATM machines and equipment supporting these machines are contained in the above FA system but the actual location is not provided in the data. An additional data extract containing the FA identifier and ATM addresses is migrated annually into CRAAFS.
Mortgage and Financial Group both maintain separate databases and spreadsheets for their assets.
   Assets not Included in Filing:
Purchasing Card System. In prior years, the inclusion of Purchasing Card transactions was not pursued due to a lack of transactional detail required for qualification and audit, within the system. Subsequently, the P-card system has received an upgrade that facilitates details. Decision was made by Corp Tax to continue to exclude P-card transactions due to the understanding that P-card transactions that are capitalized are fed into the Fixed Assets system.
   Record Keeping:
   California

FTB publication describes required record keeping to include sales receipts and proof of payment along with all records that describes:
The property purchased such as serial numbers. These items where available are found within a text description field.
The amount of sales or use tax paid on the purchase.
The location of use.

The guidelines specify that the property be purchased from a manufacturer in California or that records be kept to substantiate “that property of comparable quality and price was not available for timely purchase in California.”

Determination and record keeping of the above are not planned under the assumption that the purchasing department's functional objective is to optimize quality and price, and under the acknowledgment that specialized bank equipment such as ATMs that fit our infrastructure are not available through multiple vendors.

Data Notes:

Peoplesoft (FA) System

Category Field in the assets table indicates the nature of the purchase. Only those purchases related to dataprocessing and communications are included for filing. New categories of assets, that were non-existant at the time of system development, must be reviewed and a table (T_REF_ASSETS_CATEGORY) must be updated for inclusion.

Location determination. Within the FA systems, the vast majority of assets puchased have their location and AU as one and the same. Efforts are being made to correct those assets whose ultimate location is not the purchasing AU. This clean up effort is planned and in progress but has not been completely implemented by the FA systems department.

State field error. Initial file provided to Corporate Tax department contained one minor error. The State field in the records does not indicate the true state of the location purchasing the property. This error is caused by prior AU reassignments that are not properly reflected in a table determining the State of an AU. The general ledger AU address table is utilized to correctly determine qualification.

System Notes:

Address scrubbing algorithm.

The same algorithm used to scrub address data for Lender Deductions is also used to process asset location and AU addresses (used when location address is invalid).

Address matching algorithm.

Asset location and AU addresses are matched to EZ using the same algorithm used for Lender Deductions (found in stored procedure SP_ADDR_UPDEZ).

For purposes of reporting and audit, all relevant data are stored in below table at the end of the stored procedure SP_ASSETS:

T_ASSETS_MASTER

| | | MS SQL | | | |
|---|---|---|---|---|---|
| | | DATA | ALLOW | | |
| PK | COLUMN NAME | TYPE | NULL | CONTENT | DEFINITION |
| 1 | PERIOD | Nvarchar | | YYYY, e.g. “2002” | Year of record |
| 1 | UNIT | nvarchar | | 3-digit alphanumeric | Bank Entity |
| 1 | ASSET_ID | nvarchar | | | FA source system identifier. |
| | QUAL_FLAG | nvarchar | 1 | “Y” or null | “Y” indicates that the below address |
| | | | | | is in an EZ and that the category of |
| | | | | | property is qualified |
| | QUAL_ADDR | nvarchar | 1 | “AU”, “LOCATION” | The source of qualifying address. |
| | | | | or “ATMSITE” | |
| | ZONE_ID | nvarchar | 1 | Zone identifier | Zone identifier of qualifying AU |
| | | | | | address. |
| | ZONE_ID_QUAL_{—} | nvarchar | 1 | Zone identifier | Zone identifier of qualifying ATM |
| | ADDR | | | | address. |
| | BOOK_NAME | nvarchar | 1 | “CORP” | TBD. Currently all records contain |
| | | | | | “CORP” |
| | GL_GROUP | nvarchar | 1 | 3-digit integer | General ledger code |
| | CATEGORY | nvarchar | 1 | 2 to 4 digit | Property category code. Category |
| | | | | alphabetical | qualification is maintained in |
| | | | | | T_REF_ASSETS_CATEGORY |
| | ACCOUNT | Float | 1 | 5 or 6 digit integer | TBD. Possibly the general ledger |
| | | | | | accounting line. |
| | AU | Nvarchar | 1 | 1 to 5 digit integer | Purchasing Accounting Unit |
| | LOCATION | Nvarchar | 1 | 5 digit integer | ATM address identifier |
| | ATM_SITEID | Nvarchar | 1 | 2 to 5 digit integer | ATM slot identifier |
| | ATMID | Nvarchar | 1 | 4-digit integer | ATM identifier |
| | | | | followed by an | |
| | | | | alphabet | |
| | MAC_CODE | Nvarchar | 1 | NULL | WFB internal mail code |
| | DESCR | Nvarchar | 1 | Any combination of | Property description that is not |
| | | | | product/vendor | standardized |
| | | | | description and | |
| | | | | identifier | |
| | COST | Float | 1 | Dollar amount to | Post sales tax cost of property |
| | | | | various decimal | |
| | | | | places | |
| | PRETAX_COST | Float | 1 | Dollar amount to | Pre sales tax cost of property |
| | | | | various decimal | |
| | | | | places | |
| | SALES_TAX | Float | 1 | Percentage value to | Sales tax rate of ZONE_ID |
| | | | | various decimal | |
| | | | | places | |
| | CREDIT | Float | 1 | Dollar amount to | Sales tax paid |
| | | | | various decimal | |
| | | | | places | |
| | ACQ_DATE | Smalldatetime | 1 | YYYY-MM-DD | Date of property acquisition |
| | | | | timestamp | |
| | ADDRESS_1 | nvarchar | 1 | | Address line of qualifying address if |
| | | | | | qualified, else location address |
| | | | | | provided by FA |
| | CITY | Nvarchar | 1 | | City name of qualifying address if |
| | | | | | qualified, else location city provided |
| | | | | | by FA |
| | COUNTY | Nvarchar | 1 | | County name of qualifying address |
| | | | | | if qualified, else location county |
| | | | | | provided by FA |
| | ST | Nvarchar | 1 | 2 digit alphabetical | State abbreviation of qualifying |
| | | | | characters for US | address if qualified, else location |
| | | | | states | state provided by FA |
| | POSTAL | Nvarchar | 1 | 5-digit US Postal | Postal ZIP code of qualifying |
| | | | | ZIP | address if qualified, else location zip |
| | | | | | provided by FA |

T_ASSETS_FINANCIAL_MASTER

| | | MS SQL | ALLOW | | |
|---|---|---|---|---|---|
| PK | COLUMN NAME | DATA TYPE | NULL | CONTENT | DEFINTION |
| | PERIOD | Char | 1 | YYYY, e.g. “2002” | Year of record |
| | Corp | Nvarchar | 1 | 4-digit integer or | Bank enitity |
| | | | | NULL in rare cases | |
| | Branch | Nvarchar | 1 | 4-digit integer | Asset branch location identifier |
| | Category | Nvarchar | 1 | 5-digit integer | Asset category; not accurate |
| | | | | | enough to determine qualifiable |
| | Dept | Nvarchar | 1 | 4_digit integer or null | Department |
| | Asset | nvarchar | 1 | 8 or 9 digit integer | Asset identifier |
| | Acquired | nvarchar | 1 | YYYY-MM | Asset aquired date |
| | QUAL_FLAG | varchar | 1 | “Y” or null | Qualified flag |
| | ZONE_ID | nvarchar | 1 | Zone identifier | Zone identifier of branch address |
| | EXCLUDE | char | 1 | “Y” or NULL | Manually entered based on |
| | | | | | DESCRIPTION and |
| | | | | | ADDITIONAL_DESCRIPTION |
| | Description | nvarchar | 1 | Any combination of | Asset description |
| | | | | product/vendor | |
| | | | | description and identifier | |
| | Additional_Description | nvarchar | 1 | Any combination of | Second line of asset description |
| | | | | product description and | |
| | | | | identifier | |
| | Vendor | nvarchar | 1 | Alphanumeric identifer | Vendor identifier and name |
| | | | | “/” vendor name | |
| | Model | nvarchar | 1 | Alphanumeric identifer | Product model identifier |
| | Serial_nbr | nvarchar | 1 | Alphanumeric identifer | Product serial number |
| | Cost | float | 1 | Dollar amount to various | Post sales tax cost of property |
| | | | | decimal places | |
| | SALES_TAX | float | 1 | Percentage value to | Sales tax rate of ZONE_ID |
| | | | | various decimal places | |
| | PRETAX_COST | float | 1 | Dollar amount to various | Pre sales tax cost of property |
| | | | | decimal places | |
| | CREDIT | float | 1 | Dollar amount to various | Sales tax paid |
| | | | | decimal places | |

T_ASSETS_MORTGAGE_MASTER

It should be appreciated that contrary to expectations, the combination of PERIOD, LEVEL_NUM, and ASSET_NUM does not result in unique records and cannot be used to create primary keys. There appears to be a duplication of records as assets data is joined to multiple address records in the original data extract from the Mortgage system. This error occurs in a very small percentage of records and may be ignored for the time being.

| | | DATA | ALLOW | | |
|---|---|---|---|---|---|
| PK | COLUMN NAME | TYPE | NULL | CONTENT | DEFINITION |
| | PERIOD | varchar | 1 | YYYY, e.g. “2002” | Year of record |
| | LEVEL_NUM | nvarchar | 1 | 4-digit integer | A primary identifier for records |
| | ASSET_NUM | nvarchar | 1 | 5 or 6 digit integer | Asset Identifier |
| | DESCRIPTION | nvarchar | 1 | | Asset Description |
| | EXCLUDE | nvarchar | 1 | “Y” or NULL | Manually entered based on |
| | | | | | DESCRIPTION |
| | QUAL_FLAG | char | 1 | “Y” or NULL | Qualified flag |
| | ZONE_ID | nvarchar | 1 | Zone Identifier | Zone Identifier |
| | COST | float | 1 | Dollar amount to various | |
| | | | | decimal places | |
| | PRETAX_COST | float | 1 | Dollar amount to various | |
| | | | | decimal places | |
| | SALES_TAX | float | 1 | | |
| | CREDIT | float | 1 | Dollar amount to various | |
| | | | | decimal places | |
| | VENDOR_NUMBER | nvarchar | 1 | 6-digit alphanumeric | Vendor Identifier |
| | VENDOR_NAME | nvarchar | 1 | Either Vendor Name | Vendor Name |
| | | | | or Purchase Order | |
| | | | | Number | |
| | ADDRESS | nvarchar | 1 | | Address line of asset location |
| | SUITE | nvarchar | 1 | | Address line 2 of asset location |
| | CITY | nvarchar | 1 | | City of asset location |
| | STATE | nvarchar | 1 | 2 digit alphabetical | State of asset location |
| | | | | characters for US states | |
| | ZIP | nvarchar | 1 | 5-digit US Postal ZIP | ZIP of asset location |
| | COUNTY | nvarchar | 1 | | County of asset location |

T_REF_ASSETS_CATEGORY

| Field Name | Data Type | Data Source | Field Defined |
|---|---|---|---|
| CATEGORY | nvarchar(10), | FA | Category code |
| | PK | | |
| CATEGORY_DESCR | nvarchar(20) | Manual Entry | For reference only |
| QUAL_FLAG | nvarchar(1) | Manual Entry | “Y” is entered for qualifying category. |
| | | | “N” is entered for non-qualifying |
| | | | category. |
| | | | Blank entry indicates that the category |
| | | | has not yet been reviewed. |

It should be appreciated that as of documentation date, the following records are included in T_REF_ASSETS_CATEGOR

| CATEGORY | CATEGORY_DESCR | QUAL_FLAG |
|---|---|---|
| AUTO | Automotive | N |
| BLDG | Building | N |
| CBSE | Telecomm? | Y |
| COMP | Computer/ATM | Y |
| CRT | Networking? | Y |
| DISK | Disk Drives | Y |
| FE | Furniture | N |
| FNART | Fine Art | N |
| LHI | UNDEF | N |
| MICR | Check Processing | Y |
| OM | Outside Manufacturer? | Y |
| PC | Personal Computer | Y |
| PRTR | Printer | Y |
| SOFT | Software | Y |

Automatic Insertion, Manual Update:

The below stored procedure automatically inserts into T_REF_ASSETS_CATEGORY new category codes found in FA extracts. Such codes are processed as non-qualifying until QUAL_FLAG field is manually updates as Y.

```
SP_REF_ASSETS_CATEGORY_INS:
    BEGIN
    INSERT INTO T_REF_ASSETS_CATEGORY
    (CATEGORY)
    SELECT DISTINCT CATEGORY
    FROM T_ASSETS
    WHERE CATEGORY NOT IN
    (SELECT CATEGORY FROM T_REF_ASSETS_CATEGORY)
    END
```

Exemplary Example Exception Tables

Following are three exemplary example exception tables according to the invention.

Table F is used to convert common abbreviations and also to correct common misspellings according to the invention.

TABLE F

| ADDR_SUFFIX_SHORT | ADDR_SUFFIX |
|---|---|
| AL | ALLEY |
| ALY | ALLEY |
| AV | AVENUE |
| AVE | AVENUE |
| AVUENUE | AVENUE |
| BL | BOULEVARD |
| BLV | BOULEVARD |
| BLVD | BOULEVARD |
| BV | BOULEVARD |
| BVD | BOULEVARD |
| CIR | CIRCLE |
| CMN | COMMON |
| COR | COURT |
| CR | CIRCLE |
| CRT | COURT |
| CT | COURT |
| DR | DRIVE |
| DRIV | DRIVE |
| DRV | DRIVE |
| EXPY | EXPRESSWAY |
| FRWY | FREEWAY |
| HIGHWY | HIGHWAY |
| HWY | HIGHWAY |
| LN | LANE |
| LNE | LANE |
| LOOP | LOOP |
| PARKWY | PARKWAY |
| PKW | PARKWAY |
| PKWY | PARKWAY |
| PKY | PARKWAY |
| PL | PLACE |
| PLZ | PLAZA |
| PRKWAY | PARKWAY |
| PRKWY | PARKWAY |
| PROM | PROMENADE |
| PW | PARKWAY |
| PWY | PARKWAY |
| PZ | PLAZA |
| RD | ROAD |
| ROW | ROW |
| RTE | ROUTE |
| SQ | SQUARE |
| SQR | SQUARE |
| ST | STREET |
| STR | STREET |
| TE | TERRACE |
| TER | TERRACE |
| TERR | TERRACE |
| TR | TRAIL |
| TRL | TRAIL |
| WY | WAY |

Table G corrects specific addresses which have been entered incorrectly.

TABLE G

| ADDR_ERROR | ADDR |
|---|---|
| 10503 SAN JAUN AVE | 10503 SAN JUAN AVE |
| 1060 OAKMOUNT DRIVE | 1060 OAKMONT DRIVE |
| 1176 ROSEMARY LN | 1176 ROSEMARIE LANE |
| 1358 RAYMOND AVUENUE | 1358 RAYMOND AVENUE |
| 136 APT A TRENTON ST | 136 TRENTON ST APT A |
| 1474 SHAFFER AVE | 1474 SHAFTER AVE |
| 1502 N DURATE ST | 1502 N DURANT ST |
| 2236 E17TH ST | 2236 E 17TH ST |
| 2304 E21ST ST #C | 2304 E 21ST ST #C |
| 2701 WELLS FARGO WAY | 2701 E. 26TH ST |
| 285 FAIRMONT | 285 FAIRMOUNT |
| 333 S SPRINGS | 333 S. SPRING ST |
| 38630 PALMS DR | 38630 PALM DR |
| 4736 MELDON DRV | 4736 MELDON DRIVE |
| 5468 N LONG BEACH BLVD NO 4 | 5468 LONG BEACH BLVD |
| | #4 |
| 7ATTN: ALICIA MCLAUGHLIN | 7155 VALJEAN AVE |
| 930 PAVLIN AVE | 930 PAULIN AVE |
| 979 SANTANA ST | 979 SANTA ANA ST |
| MSC 6352 233 PAULIN AVE | 233 PAULIN AVE |
| NO 459 VILLAGE DR | 459 VILLAGE DR |

Table H shows part of a table for Arizona and California used to correct commonly misspelled city names.

TABLE H

| STATE | CITY_ERROR | CITY |
|---|---|---|
| AL | EUTAN | EUTAW |
| AL | EUTAU | EUTAW |
| AZ | FALGSTAFF | FLAGSTAFF |
| AZ | FLAQSTAFF | FLAGSTAFF |
| AZ | PHEONIX | PHOENIX |
| AZ | PHOENI | PHOENIX |
| AZ | PHOENIC | PHOENIX |
| AZ | PHOENIZ | PHOENIX |
| AZ | PHOENOX | PHOENIX |
| AZ | PHONEIX | PHOENIX |
| AZ | PHONIX | PHOENIX |
| AZ | PHX | PHOENIX |
| AZ | PNOENIX | PHOENIX |
| AZ | TUBA CITY | TUBA |
| AZ | TUCCON | TUCSON |
| AZ | TUESON | TUCSON |
| AZ | TULSA | TUCSON |
| AZ | TULSON | TUCSON |
| AZ | TUSCON | TUCSON |
| AZ | TUZSON | TUCSON |
| CA | OAKLAND | OAKLAND |
| CA | ORANGE | ORANGE |
| CA | ACRAMENTO | SACRAMENTO |
| CA | ADELANDO | ADELANTO |
| CA | AGORA HILLS | AGOURA HILLS |
| CA | AGOURA | AGOURA HILLS |
| CA | AGOURA HILL | AGOURA HILLS |
| CA | AGUORA HILLS | AGOURA HILLS |
| CA | AGURA HILLS | AGOURA HILLS |
| CA | AIHAMBRA | ALHAMBRA |
| CA | ALAMBRA | ALHAMBRA |
| CA | ALAMEDA POINT | ALAMEDA |
| CA | ALANEDA | ALAMEDA |
| CA | ALANIEDA | ALAMEDA |
| CA | ALCHAMBRA | ALHAMBRA |
| CA | ALDMO | ALAMO |
| CA | ALEMEDA | ALAMEDA |
| CA | ALH | ALHAMBRA |
| CA | ALHAMABRA | ALHAMBRA |
| CA | ALHAMBAR | ALHAMBRA |
| CA | ALHAMBARA | ALHAMBRA |
| CA | ALHAMBRA CITY | ALHAMBRA |
| CA | ALHAMBRA VALLEY | ALHAMBRA |
| CA | ALISA VIEJO | ALISO VIEJO |
| CA | ALISIO VIEJO | ALISO VIEJO |
| CA | ALISO VEIJO | ALISO VIEJO |
| CA | ALISO VEJO | ALISO VIEJO |
| CA | ALISO VIEGO | ALISO VIEJO |
| CA | ALISO VIESO | ALISO VIEJO |
| CA | ALISO VIETO | ALISO VIEJO |
| CA | ALMEDA | ALAMEDA |
| CA | ALMO | ALAMO |
| CA | ALNAMBRA | ALHAMBRA |
| CA | ALSO VIEJO | ALISO VIEJO |
| CA | ALTA | ALTA LOMA |
| CA | ALTA COMA | ALTA LOMA |
| CA | ALTA LANE | ALTA LOMA |
| CA | ALTADENDA | ALTADENA |
| CA | ALTADINA | ALTADENA |
| CA | ALTADNA | ALTADENA |
| CA | ALTALOMA | ALTA LOMA |
| CA | ALTO LOMA | ALTA LOMA |
| CA | AMERICA CANYON | AMERICAN CANYON |
| CA | ANADINA | ALTADENA |
| CA | ANAHAEIM | ANAHEIM |
| CA | ANAHEIM HILLS | ANAHEIM |
| CA | ANAHEIN | ANAHEIM |
| CA | ANAHIEM | ANAHEIM |
| CA | ANAHIEM HILLS | ANAHEIM |
| CA | ANAHIM | ANAHEIM |
| CA | ANALOPE | ANTELOPE |
| CA | ANANEIM | ANAHEIM |
| CA | ANANEIM HILLS | ANAHEIM |
| CA | ANANHEIAM HILLS | ANAHEIM |
| CA | ANATEIN | ANAHEIM |
| CA | ANGELS CAMP | ANGELS |
| CA | ANGELUS OAKS | ANGELS |
| CA | ANHEIM | ANAHEIM |
| CA | ANITOCH | ANTIOCH |
| CA | ANNOCH | ANTIOCH |
| CA | ANTICCH | ANTIOCH |

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. A method to sort enterprise zone addresses into a consistent format, comprising the steps of:
based on an input file provided by a state, determining an address range for each zone;
copying data corresponding to said address range and saving said copied data as a text file;
importing and parsing said saved data into a spreadsheet application;
manually placing address components into correct columns when said importing and parsing results in misalignment; and
iteratively repeating said steps starting from determining an address range until done;
combining all spreadsheet files into one final spreadsheet file.

2. The method of claim 1, wherein said input file is a PDF file.

3. The method of claim 1, wherein said imported file is a text delimited file.

4. The method of claim 1, wherein said imported data is parsed into parsed into five columns: range: [from (street number), to (street number)], side (odd or even), direction (compass), street name, and suffix.

5. The method of claim 1, said parsing step further comprising the step:
concatenating street names having two or more words.

6. The method of claim 4, said parsing step further comprising the step:
if a city opts to put a direction in front of a street name, then removing said direction from said street name and putting said direction into a direction column, and in the case when said direction is in front of said street name and in said direction column, then said direction is left alone.

7. The method of claim 4, said parsing step further comprising the step:
if said side is named as “only”, then a same street number is written in both said from and said to columns and said side is changed to “both”.

8. The method of claim 4, further comprising providing a sixth column for zone ID's.

9. The method of claim 1, further comprising the step of:
adjusting said text file before said importing step.

10. The method of claim 1, wherein said final spreadsheet file is used for input into a module for calculating net interest deduction for lenders.

11. The method of claim 1, wherein said final spreadsheet file is used for input into a module for calculating employee hiring credit.

12. The method of claim 1, wherein said final spreadsheet file is used for input into a module for calculating sales and use credit.

13. A system providing scrubbed and mapped data for obtaining tax credit, comprising:
an input module parsing and storing raw data from a variety of formats into a single resultant format;
a scrubbing module receiving input data from said input module and encoding input data into a consistent format by applying scrubbing rules;
a mapping module receiving scrubbed data from said scrubbing module and encoding said scrubbed data into a mapped format by applying mapping rules; and
an output module for outputting said mapped data into an output format usable by tax credit representatives to apply for tax credit.

14. The system of claim 13, wherein said system adds a date range for a particular zone, thereby indicating when said zone is in effect.

15. The system of claim 13, wherein said mapping module can be modified to include zone qualifiers of new zones.

16. The system of claim 15, wherein said new zones are associated with states.

17. The system of claim 13, wherein said scrubbing module processes exceptions.

18. The system of claim 17, wherein the exceptions are stored in exception files.

19. The system of claim 13, wherein said output file from said output module is used in any of:
calculating net interest deduction for lenders;
calculating employee hiring credit; and
calculating sales and use credit.
